(19) United States
(12) Patent Application Publication
(10) Pub. No.: US 2023/0232458 A1
(43) Pub. Date: Jul. 20, 2023

(54) Random Access Response in a Wireless Communication Network

(71) Applicant: Telefonaktiebolaget LM Ericsson (publ), Stockholm (SE)

(72) Inventors: Jan Christoffersson, Luleå (SE); Min Wang, Luleå (SE)

(21) Appl. No.: 18/029,150

(22) PCT Filed: Sep. 29, 2020
(86) PCT No.: PCT/SE2020/050914

§ 371 Date: Mar. 29, 2023

(51) Int. Cl. H04W 74/08

(52) U.S. Cl. CPC H04W 74/0833

(57) ABSTRACT

Embodiments herein include a method performed by a radio network node (12) configured for use in a wireless communication network (10). The method comprises receiving a message (16) of a procedure for random access by a wireless device (14) to a cell served by the radio network node (12). The method also comprises selecting, as a function of on which uplink bandwidth part (30-0 . . . 30-N) of the cell the message (16) was received and/or as a function of an information field (16A) of the message (16), a format of a random access response (18) to be transmitted as a response to the message (16). The method also comprises transmitting the random access response (18) with the selected format (16).

### TECHNICAL FIELD

The present application relates generally to a wireless communication network, and relates more particularly to random access in such a network.

### BACKGROUND

A wireless device performs random access in a wireless communication network to, for example, acquire uplink synchronization or establish or resume a radio resource control (RRC) connection. The traditional contention-based random access procedure includes 4 steps in which the wireless device and network engage in two successive rounds of a wireless device transmission and a network response. To reduce the duration of the procedure and corresponding latency attributable to the procedure, a 2-step random access procedure condenses the procedure into only one round of a wireless device transmission and a network response. No matter the number of steps taken for random access, keeping the size of a network response message as small as possible conserves scarce radio resources and increases random access coverage.

### SUMMARY

According to some embodiments herein, a radio network node selects a format of a random access response to be transmitted as a response to a message of a random access procedure. The format may be selected, for instance, from among different candidate formats that have different sizes, e.g., sizes narrowly tailored for different respective random access triggering events so as to minimize response size. In these and other embodiments, the radio network node may select the format as a function of on which uplink bandwidth part of a cell the radio network node received the message. For example, different types of uplink bandwidth parts may be associated with different random access response formats, such that transmission of the message on a certain type of uplink bandwidth part (e.g., initial vs. non-initial) implicitly signals the format to be used for the response. Alternatively or additionally, the radio network node may select the format as a function of an information field of the message, e.g., which may explicitly indicate the format to be used for the response. In any event, selecting a format of a random access response in these or other ways may advantageously facilitate minimizing the size of the random access response, which in turn conserves scarce radio resources and may increase random access coverage.

More particularly, embodiments herein include a method performed by a radio network node configured for use in a wireless communication network. The method comprises receiving a message of a procedure for random access by a wireless device to a cell served by the radio network node. The method also comprises selecting, as a function of on which uplink bandwidth part of the cell the message was received and/or as a function of an information field of the message, a format of a random access response to be transmitted as a response to the message. The method also comprises transmitting the random access response with the selected format.

In regards to the method performed by a radio network node, different types of uplink bandwidth parts of the cell may for example be associated with different random access response formats and/or different Radio Resource Control states and/or different random access triggering events.

In some embodiments, selecting a format of a random access response to be transmitted comprises selecting the format from among different candidate formats that have different sizes and/or at least some different fields.

In some embodiments, selecting a format of a random access response comprises selecting the format as a function of whether an uplink bandwidth part on which the message was received is an initial uplink bandwidth part or a non-initial uplink bandwidth part.

In some embodiments, selecting a format of a random access response comprises selecting the format to be a first format if the message was received on an initial uplink bandwidth part and selecting the format to be a second format if the message was received on a non-initial uplink bandwidth part, with the second format being smaller in size than the first format and/or having fewer fields than the first format. In other embodiments, selecting a format of a random access response comprises selecting the format to be a first format if the information field indicates the random access response is to have the first format and selecting the format to be a second format if the information field indicates the random access response is to have the second format, with the second format being smaller in size than the first format and/or having fewer fields than the first format. In still other embodiments, selecting a format of a random access response comprises selecting the format to be a first format if the information field indicates the wireless device is not in an RRC Connected state and selecting the format to be a second format if the information field indicates the wireless device is in an RRC Connected state, with the second format being smaller in size than the first format and/or having fewer fields than the first format. In any of these embodiments with a first format and a second format, the first format may include a Temporary Cell Radio Network Temporary Identifier, TC-RNTI, field or a Cell Radio Network Temporary Identifier, C-RNTI, field, and the second format may lack both a TC-RNTI field and a C-RNTI field. Alternatively or additionally, the first format may include a timing advance command, TAC, field and the second format may lack a TAC field.

In some embodiments, the selected format lacks a timing advance command, TAC, field. Alternatively or additionally, the selected format may lack both a Temporary Cell Radio Network Temporary Identifier, TC-RNTI, field and a Cell Radio Network Temporary Identifier, C-RNTI, field.

In some embodiments, the method performed by a radio network node further comprises receiving a further message of the random access procedure after transmitting the random access response, and blindly decoding the further message using one or more Cell Radio Network Temporary Identifiers, C-RNTIs, allocated to one or more wireless devices that have a Radio Resource Control, RRC, connection established with the radio network node based on selecting the format of the random access response to be a format that lacks a Temporary Cell Radio Network Temporary Identifier, TC-RNTI, field.

In some embodiments, selecting a format of a random access response is performed also as a function of which random access preamble is included in the received message. Different sets of random access preambles in this case are associated with different random access response formats and/or different Radio Resource Control states and/or different random access triggering events. Selecting a format of a random access response may also or alternatively be performed as a function on which random access resource the message is received. Different sets of random access resources in this case are associated with different random access response formats and/or different Radio Resource Control states and/or different random access triggering events.

In some embodiments, selecting a format of a random access response is performed also as a function of a radio coverage level of the wireless device. Alternatively or additionally, selecting a format of a random access response may be performed also as a function of a subcarrier spacing used for the procedure.

In regards to the method performed by a radio network node, the information field in some embodiments explicitly indicates either a format of the random access response to be transmitted, a Radio Resource Control state of the wireless device, or a triggering event that triggered the procedure for random access.

Embodiments herein also include a method performed by a wireless device configured for use in a wireless communication network. The method comprises transmitting a message of a procedure for random access to a cell. The message is transmitted on an uplink bandwidth part selected based on a Radio Resource Control, RRC, state of the wireless device. Alternatively or additionally, the message includes an information field that explicitly indicates the RRC state of the wireless device, or a triggering event that triggered the procedure, or a format of a random access response to be transmitted as a response to the message.

In some embodiments, the method performed by a wireless device further comprises selecting the uplink bandwidth part on which to transmit the message based on the RRC state of the wireless device, and transmitting the message on the selected uplink bandwidth part. In one embodiment, selecting the uplink bandwidth part comprises selecting a non-initial uplink bandwidth part as the uplink bandwidth part on which to transmit the message if the wireless device is in an RRC Connected state, and selecting an initial uplink bandwidth part as the uplink bandwidth part on which to transmit the message if the wireless device is not in an RRC Connected state.

In some embodiments, different types of uplink bandwidth parts of the cell may be associated with different random access response formats, and/or different Radio Resource Control states, and/or different random access triggering events.

In some embodiments, the method further comprises setting the information field to indicate the format of the random access response as being a first format if the wireless device is not in an RRC Connected state, and setting the information field to indicate the format of the random access response as being a second format if the wireless device is in an RRC Connected state. In this case, the second format may be smaller in size than the first format and/or may have fewer fields than the first format.

In some embodiments, the method further comprises receiving a random access response as a response to the message, with the random access response having a format that is a function of on which uplink bandwidth part of the cell the message was transmitted. In one such embodiment, the method further comprises selecting a format according to which to process the random access response as a function of on which uplink bandwidth part of the cell the message was transmitted and/or the RRC state of the wireless device, and processing the random access response according to the selected format. For example, selecting the format may comprise selecting the format from among different candidate formats that have different sizes and/or at least some different fields. Alternatively or additionally, selecting the format may comprise selecting the format as a function of whether an uplink bandwidth part on which the message was transmitted is an initial uplink bandwidth part or a non-initial uplink bandwidth part. In still other embodiments, selecting the format comprises selecting the format to be a first format if the message was transmitted on an initial uplink bandwidth part, and selecting the format to be a second format if the message was transmitted on a non-initial uplink bandwidth part, with the second format being smaller in size than the first format and/or having fewer fields than the first format. In one such embodiment, the selected format lacks a timing advance command, TAC, field. Alternatively or additionally, the selected format lacks both a Temporary Cell Radio Network Temporary Identifier, TC-RNTI, field and a Cell Radio Network Temporary Identifier, C-RNTI, field.

In some embodiments, the selected format lacks a timing advance command, TAC, field. Alternatively or additionally, the selected format lacks both a Temporary Cell Radio Network Temporary Identifier, TC-RNTI, field and a Cell Radio Network Temporary Identifier, C-RNTI, field.

In some embodiments, selecting the format is performed also as a function of which random access preamble is included in the transmitted message. Different sets of random access preambles may be associated with different random access response formats, and/or different Radio Resource Control states, and/or different random access triggering events. Selecting the format may for example also or alternatively be performed as a function of on which random access resource the message is transmitted. Different sets of random access resources may be associated with different random access response formats, and/or different Radio Resource Control states, and/or different random access triggering events.

In some embodiments, selecting the format is performed also as a function of a radio coverage level of the wireless device.

In some embodiments, selecting the format is performed also as a function of a subcarrier spacing used for the procedure.

Embodiments herein also include a radio network node configured for use in a wireless communication network. The radio network node is configured to receive a message of a procedure for random access by a wireless device to a cell served by the radio network node. The radio network node is also configured to select a format of a random access response to be transmitted as a response to the message as a function of on which uplink bandwidth part of the cell the message was received and/or as a function of an information field of the message. The radio network node is also configured to transmit the random access response with the selected format.

In some embodiments, the radio network node is configured to perform any of the method steps described above for the radio network node.

Embodiments herein also include a wireless device configured for use in a wireless communication network. The wireless device is configured to transmit a message of a procedure for random access to a cell. The message is transmitted on an uplink bandwidth part selected based on a Radio Resource Control, RRC, state of the wireless device, and/or includes an information field that explicitly indicates the RRC state of the wireless device, or a triggering event that triggered the procedure, or a format of a random access response to be transmitted as a response to the message.

In some embodiments, the wireless device is configured to perform any of the method steps described above for a wireless device.

In some embodiments, a computer program comprises instructions which, when executed by at least one processor, causes a radio network node to perform any of the method steps described above for the radio network node of the radio network node configured for use in a wireless communication network. In some embodiments, a computer program comprises instructions which, when executed by at least one processor of the wireless device, cause a wireless device to perform any of the method steps described above for the wireless device configured for use in a wireless communication network. A carrier may for example contain the computer program. The carrier may for example be one of an electronic signal, optical signal, radio signal, or computer readable storage medium.

Embodiments herein also include a radio network node configured for use in a wireless communication network. The radio network node comprises communication circuitry and processing circuitry. The processing circuitry is configured to receive a message of a procedure for random access by a wireless device to a cell served by the radio network node. The processing circuitry is also configured to select a format of a random access response to be transmitted as a response to the message as a function of on which uplink bandwidth part of the cell the message was received and/or as a function of an information field of the message. The processing circuitry is also configured to transmit the random access response with the selected format.

In some embodiments, the processing circuitry is configured to perform any of the method steps described above for the radio network node.

Embodiments herein also include a wireless device configured for use in a wireless communication network. The wireless device comprises communication circuitry and processing circuitry. The processing circuitry is configured to transmit a message of a procedure for random access to a cell. The message is transmitted on an uplink bandwidth part selected based on a Radio Resource Control, RRC, state of the wireless device, and/or includes an information field that explicitly indicates the RRC state of the wireless device, or a triggering event that triggered the procedure, or a format of a random access response to be transmitted as a response to the message.

In some embodiments, the processing circuitry is configured to perform any of the method steps described above for the wireless device.

### BRIEF DESCRIPTION OF THE DRAWINGS

FIG. 1 is a block diagram of a wireless communication network according to some embodiments.

FIG. 2A is a block diagram of an association between scenarios and formats of a random access response according to some embodiments.

FIG. 2B is a block diagram of an association between random access triggering events and formats of a random access response according to some embodiments.

FIG. 2C is a block diagram of an association between RRC states and formats of a random access response according to some embodiments.

FIG. 2D is a block diagram of an association between timing advance statuses and formats of a random access response according to some embodiments.

FIGS. 3A-3C are block diagrams of different respective candidate formats of a random access response according to some embodiments.

FIGS. 4A-4C are block diagrams of different respective candidate formats of a random access response according to other embodiments.

FIGS. 5A-5C are block diagrams of different respective candidate formats of a random access response according to still other embodiments.

FIG. 6 is a block diagram of a wireless communication network according to some embodiments where a format of a random access response is selected as a function of an information field.

FIG. 7 is a block diagram of a wireless communication network according to some embodiments where a format of a random access response is selected as a function of an uplink bandwidth part on which a message is received.

FIG. 8A is a block diagram of an association between bandwidth parts and formats of a random access response according to some embodiments.

FIG. 8B is a block diagram of an association between bandwidth part types and formats of a random access response according to some embodiments.

FIG. 9 is a call flow diagram of a 4-step random access procedure according to some embodiments.

FIG. 10 is a call flow diagram of a 2-step random access procedure according to some embodiments.

FIG. 11 is a block diagram of a Medium Access Control (MAC) protocol data unit (PDU) that includes a MAC random access response (RAR) according to some embodiments.

FIG. 12 is a logic flow diagram of a method performed by a radio network node according to some embodiments.

FIG. 13A is a logic flow diagram of a method performed by a wireless device according to some embodiments.

FIG. 13B is a logic flow diagram of a method performed by a wireless device according to other embodiments.

FIG. 13C is a logic flow diagram of a method performed by a wireless device according to yet other embodiments.

FIG. 14 is a block diagram of a radio network node according to some embodiments.

FIG. 15 is a block diagram of a wireless device according to some embodiments.

FIG. 16 is a block diagram of a wireless communication network according to some embodiments.

FIG. 17 is a block diagram of a user equipment according to some embodiments.

FIG. 18 is a block diagram of a virtualization environment according to some embodiments.

FIG. 19 is a block diagram of a communication network with a host computer according to some embodiments.

FIG. 20 is a block diagram of a host computer according to some embodiments.

FIG. 21 is a flowchart illustrating a method implemented in a communication system, in accordance with one embodiment.

FIG. 22 is a flowchart illustrating a method implemented in a communication system, in accordance with one embodiment.

FIG. 23 is a flowchart illustrating a method implemented in a communication system, in accordance with one embodiment.

FIG. 24 is a flowchart illustrating a method implemented in a communication system, in accordance with one embodiment.

### DETAILED DESCRIPTION

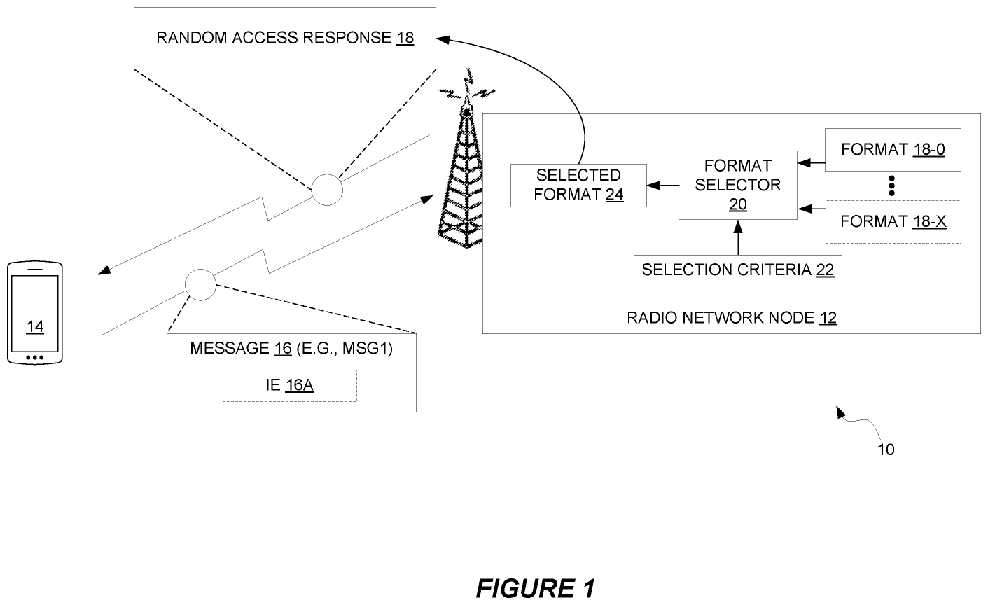

FIG. 1 shows a wireless communication network 10 (e.g., a 5G network) according to some embodiments. The wireless communication network 10 includes a radio network node 12 (e.g., a gNB) and a wireless device 14 (e.g., a user equipment, UE). The wireless device 14 is configured to perform a procedure for random access to a cell served by the radio network node 12.

FIG. 1 in this regard shows that the wireless device 14 transmits a message 16 of the random access procedure to the radio network node 12. In some embodiments, this message 16 includes or otherwise conveys a random access preamble, e.g., on a random access channel (RACH). For example, the message 16 may be Msg1 of a 4-step random access procedure or may be MsgA of a 2-step random access procedure, as later described.

Regardless, FIG. 1 shows that the radio network node 12 correspondingly receives the message 16 and transmits a random access response 18 as a response to the message 16. In some embodiments, the random access response 18 is defined at a Medium Access Control (MAC) layer. The random access response 18 may for example be Msg2 of a 4-step random access procedure or may be MsgB of a 2-step random access procedure. In these and other embodiments, the random access response 18 may identify the message 16 as the message to which the random access response 18 is a response. The random access response 18 may for example implicitly identify a random access preamble conveyed by the message 16 using a random access radio network temporary identifier (RA-RNTI), e.g., a cyclic redundancy check (CRC) of the random access response 18 may be scrambled using the RA-RNTI associated with the random access preamble conveyed by the message 16.

According to some embodiments herein, the radio network node 12 selects a format of the random access response 18 to be transmitted. FIG. 1 for example shows the radio network node 12 as including a format selector 20 for performing this format selection, e.g., on the basis of selection criteria 22. In some embodiments, the format of the random access response 18 defines which field(s) are included in the random access response 18 and/or the size of the field(s). As shown, for example, multiple different candidate formats 18-0 . . . 18-X may be defined as candidates for the format of the random access response 18. Different candidate formats 18-0 . . . 18-X may have different sizes and/or at least some different fields. In these and other embodiments, then, selection of a format of the random access response 18 may impact a size and/or field makeup of the random access response 18. In fact, in some embodiments, format selection narrowly tailors a size of the random access response 18 to be as small as possible. This may advantageously reduce signaling overhead (e.g., at the MAC layer), improve network coverage for random access, and/or conserve radio resources.

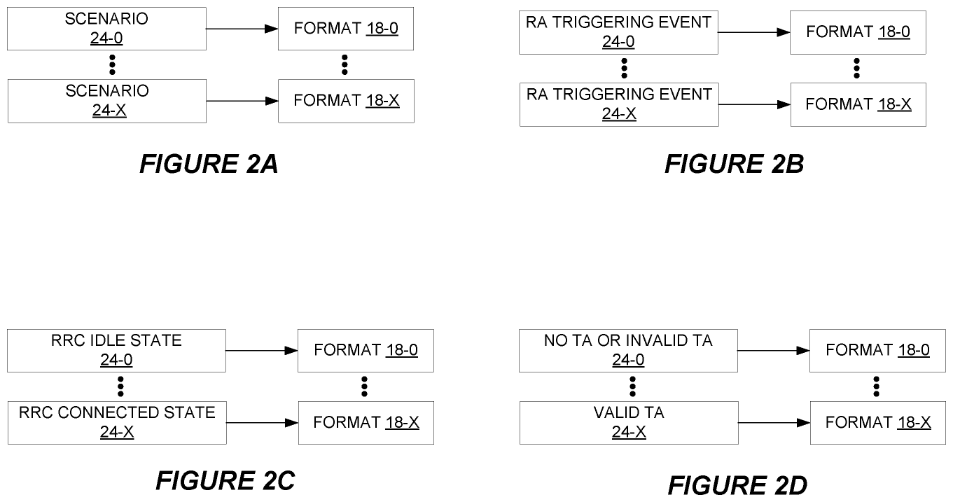

In some embodiments in this regard, FIG. 2A shows that different candidate formats 18-0 . . . 18-X may be specific for, tailored for, or otherwise associated with different respective scenarios 24-0 . . . 24-X, e.g., with format 18-0 being specific for scenario 24-0, format 18-1 being specific for scenario 24-1, and so on. For example, where different scenarios necessitate at least some different fields in a random access response, a candidate format associated with a certain scenario may have only the field(s) necessitated by that scenario. That is, each candidate format may be narrowly tailored, e.g., in terms of its fields, for a targeted scenario. Narrowly tailoring each candidate format on a scenario by scenario basis in this way advantageously enables the random access response 18 to be dynamically formatted (e.g., sized) on a scenario by scenario basis. In these and other embodiments, then, the selection criteria 22 on which format selection is based may enable differentiation between different scenarios so that format selection can select different formats for different targeted scenarios.

In one embodiment shown in FIG. 2B, for instance, the different scenarios 24-0 . . . 24-X correspond with or are based on different respective random access triggering events. In this case, format 18-0 is specific to random access triggering event 24-0, format 18-1 is specific to random access triggering event 24-1, and so on, with the understanding that in some embodiments at least one of the formats may be common to multiple random access triggering events. A random access triggering event in this regard is any event that triggers a wireless device to perform a procedure for random access. Different random access triggering events may trigger random access for different purposes or reasons. Exemplary random access triggering events include, for instance, (i) initial access from a Radio Resource Control (RRC) idle state, (ii) a RRC connection re-establishment, (iii) downlink or uplink data arrival during RRC connected state when uplink synchronization status is non-synchronized, (iv) uplink data arrival during RRC connected state when there are no physical uplink control channel resources for a scheduling request available, (v) scheduling request failure, (vi) request by RRC upon synchronous reconfiguration (e.g., handover), (vii) transition from RRC inactive state, (viii) to establish time alignment for a secondary timing advance group (TAG), (ix) request for Other system information, and (v) beam failure recovery. No matter the particular nature of the random access triggering events, though, associating different random access triggering events 24-0 . . . 24-X with respective candidate formats 18-0 . . . 18-X advantageously enables the radio network node 12 to tailor a format of the random access response 18 on an event by event basis, e.g., so that the field(s) and/or size of the random access response 18 is narrowly tailored on an event by event basis.

In another embodiment shown in FIG. 2C, by contrast, the different scenarios 24-0 . . . 24-X correspond with or are based on different respective RRC states of the wireless device for which random access is performed. In the illustrated example, for instance, format 18-0 is specific for an RRC idle state whereas format 18-X is specific for an RRC connected state. Here, an RRC idle state is a state in which the wireless device 14 does not have an RRC connection established with the radio network node 12, whereas an RRC connected state is a state in which the wireless device 14 does have an RRC connection established with the radio network node 12. Associating different RRC states with respective candidate formats 18-0 . . . 18-X advantageously enables the radio network node 12 to tailor a format of the random access response 18 on an RRC state by RRC state basis, e.g., so that the field(s) and/or size of the random access response 18 is narrowly tailored on an RRC state by RRC state basis.

In yet another embodiment shown in FIG. 2D, the different scenarios 24-0 . . . 24-X correspond with or are based on different respective timing advance (TA) statuses of the wireless device for which random access is performed. In the illustrated example, for instance, format 18-0 is specific for a scenario in which the wireless device 14 either lacks a timing advance or lacks a valid timing advance, whereas format 18-X is specific for a scenario in which the wireless device 14 has a valid timing advance. Associating different TA statuses with respective candidate formats 18-0 . . . 18-X advantageously enables the radio network node 12 to tailor a format of the random access response 18 based on whether or not the wireless device 14 has a valid timing advance.

Although not shown, the examples in FIGS. 2B-2D may be used in combination.

For example, in some embodiments, different candidate formats are specific for different respective combinations of an RRC state and a TA status. For example, candidate format 18-0 may be specific for a scenario where a wireless device is in an RRC idle state and lacks a valid TA, candidate format 18-1 may be specific for a scenario where a wireless device is in an RRC connected state but lacks a valid TA, and candidate format 18-2 may be specific for a scenario where a wireless device is in an RRC connected state and has a valid TA.

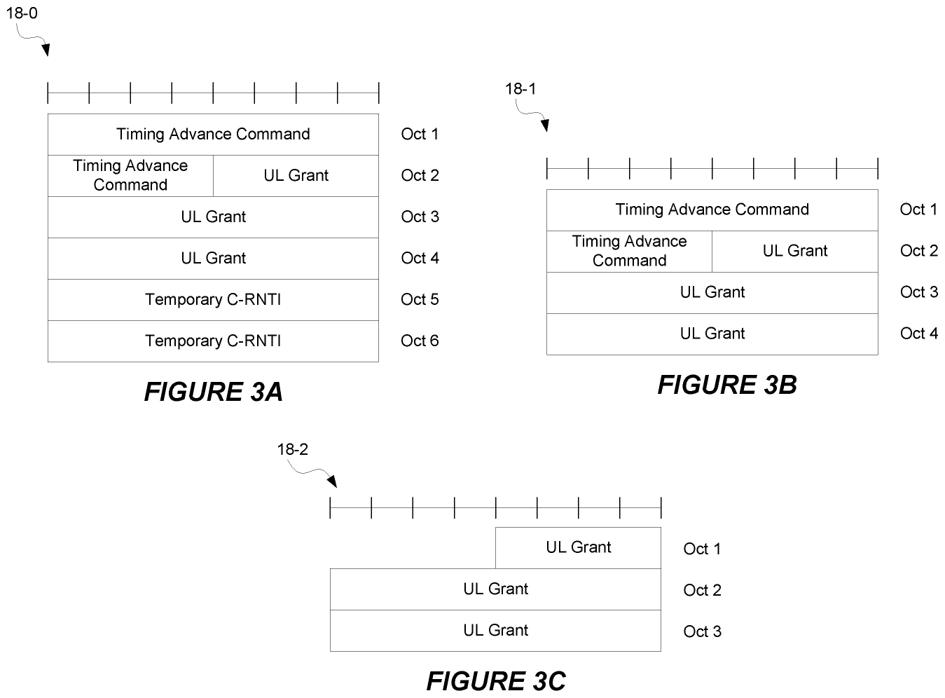

In more detail, FIGS. 3A-3C show an example of different candidate formats of a random access response according to some embodiments, e.g., for Msg2 of a 4-step random access procedure. As shown in FIG. 3A, candidate format 18-0 has a size of 6 octets and includes a timing advance command (TAC) field, an uplink (UL) grant field, and a temporary Cell Radio Network Temporary Identifier (C-RNTI) field. The TAC field indicates an index mapped to a value of a timing advance used to control the amount of timing adjustment that a wireless device is to apply to its uplink transmissions for uplink time alignment. The UL grant field indicates a grant of resources to be used by a wireless device in an uplink direction, e.g., for a data channel transmission. The temporary C-RNTI field indicates a temporary identity that is used during random access, e.g., as opposed to a (non-temporary)C-RNTI that is used during RRC Connected mode after random access. By contrast, candidate format 18-1 shown in FIG. 3B has a size of only 4 octets and includes a TAC field and an UL grant field, i.e., format 18-1 lacks a temporary C-RNTI field. Further contrasted, candidate format 18-2 shown in FIG. 3C has a size of 3 octets and includes only an UL grant field, i.e., format 18-2 lacks both a temporary C-RNTI field and an UL grant field.

In some embodiments, candidate format 18-0 in FIG. 3A is specific for a scenario in which a random access response needs to include at least a TAC field, an UL grant field, and a temporary C-RNTI field. This may be the case for any of the examples above described for scenario 24-0 in FIGS. 2A-2D. That is, in some embodiments, candidate format 18-0 in FIG. 3A is specific for a scenario where the random access procedure is for a wireless device in an RRC idle state (RRC idle state 24-0 in FIG. 2C) and/or for a wireless device that lacks a valid TA (No TA or Invalid TA 24-0 in FIG. 2D). Alternatively or additionally, candidate format 18-0 in FIG. 3A may be specific for a scenario where the random access procedure is triggered for the purpose of initial access, is triggered to establish time alignment for a secondary timing advance group (TAG), or is triggered by an RRC Connection Re-establishment procedure to re-establish an RRC Connection at a new cell. By contrast, candidate format 18-1 may be specific for a scenario in which a random access response needs to include a TAC field and an UL grant field, but does not need to include a temporary C-RNTI field. This may for instance include a scenario where the random access procedure is for a wireless device in an RRC connected state (RRC connected state 24-X in FIG. 2C) and/or for a wireless device without a valid timing advance. Alternatively or additionally, this may include a scenario where the random access procedure is triggered by downlink or uplink data arrival during RRC connected state when uplink synchronization status is non-synchronized, or is triggered to establish time alignment for a secondary timing advance group. Finally, candidate format 18-2 may be specific for a scenario in which a random access response only needs to include an UL grant field, but need not include a TAC field or a temporary C-RNTI field. This may for instance include a scenario where the random access procedure is for a wireless device in an RRC connected state (RRC connected state 24-X in FIG. 2C) and/or for a wireless device with a valid timing advance. Alternatively or additionally, this may include a scenario where the random access procedure is triggered by uplink data arrival during RRC connected state when there are no physical uplink control channel resources for a scheduling request available, is triggered by a request by RRC upon synchronous reconfiguration (e.g., handover), is triggered by a scheduling request (SR) failure, is triggered by a request for Other system information (SI), or is triggered by beam failure recovery.

Note, though, that in some embodiments there are multiple different possible types of random access responses that can be transmitted in response to the message 16, e.g., for a certain type of random access procedure such as a contention-based random access procedure. For example, in embodiments wherein the message 16 is a msgA of a 2-step random access procedure, the different possible types of random access responses can include a success response and a fallback response. A success response may be associated with successful completion of the 2-step random access procedure, whereas a fallback response may indicate to the wireless device 14 to fall back to a 4-step random access procedure. In this case where different types of random access responses exist, the different candidate formats 18-0 . . . 18-X may be defined as candidates for the format of a certain type of random access response, e.g., each type of random access response may be formatted in multiple different ways. So, there may be multiple formats for a success response and/or multiple formats for a fallback response.

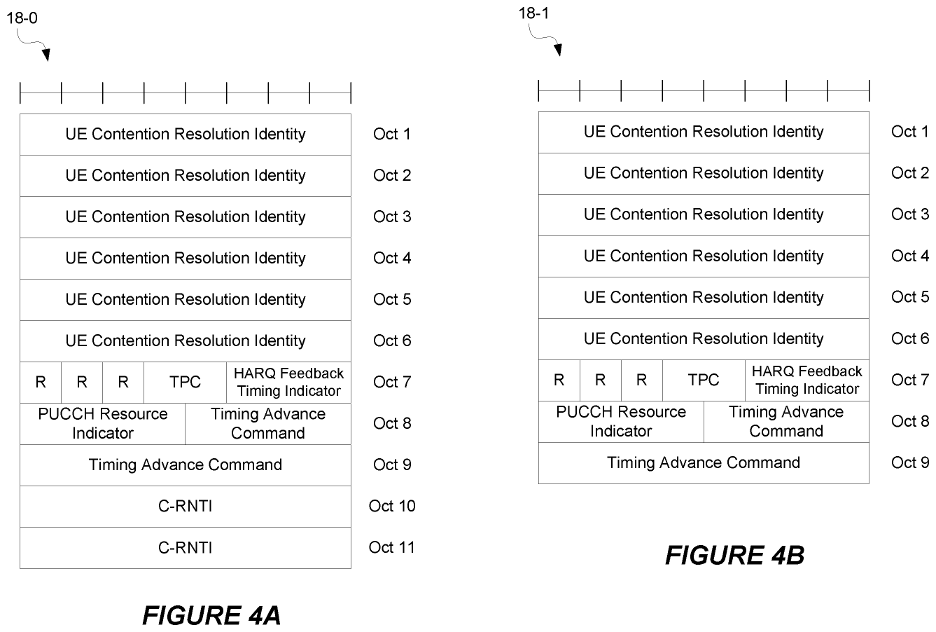

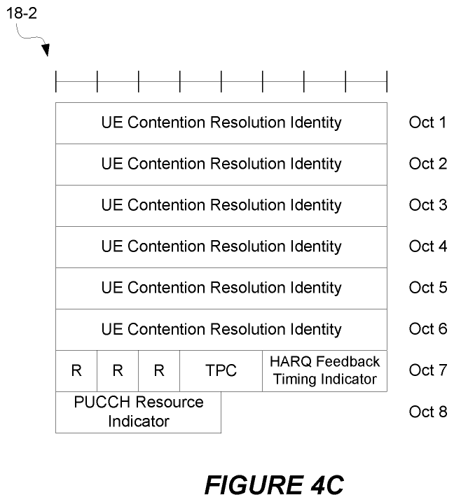

FIGS. 4A-4C in this regard show an example of different candidate formats of a random access response (e.g., MsgB) that takes the form of a success response in a 2-step random access procedure. As shown in FIG. 4A, candidate format 18-0 has a size of 11 octets and includes a user equipment (UE) contention resolution identity, 3 reserved bits, a transmit power control (TPC) field, a hybrid automatic repeat request (HARQ) feedback timing indicator field, a physical uplink control channel (PUCCH) resource indicator field, a timing advance command (TAC) field, and a Cell Radio Network Temporary Identifier (C-RNTI) field. The UE contention resolution identity field contains an uplink common control channel (CCCH) service data unit (SDU). The reserved bits are set to 0. The TPC field indicates a TPC command for the PUCCH resource containing HARQ feedback for the random access response. The TAC field indicates an index mapped to a value of a timing advance used to control the amount of timing adjustment that a wireless device is to apply to its uplink transmissions for uplink time alignment. The C-RNTI field indicates the identity that is used by the MAC entity upon completion of random access. By contrast, candidate format 18-1 shown in FIG. 4B has a size of only 9 octets and includes the same fields as format 18-0 in FIG. 4A except for the C-RNTI field, i.e., format 18-1 lacks a C-RNTI field. Further contrasted, candidate format 18-2 shown in FIG. 4C has a size of 8 octets and includes the same fields as format 18-0 in FIG. 4A except for the C-RNTI field and the TAC field, i.e., format 18-2 lacks a C-RNTI field and a TAC field.

In some embodiments, format 18-0 in FIG. 4A is specific for the same scenario(s) as those described above for format 18-0 in FIG. 3A, format 18-1 in FIG. 4B is specific for the same scenario(s) as those described above for format 18-1 in FIG. 3B, and format 18-2 in FIG. 4C is specific for the same scenario(s) as those described above for format 18-3 in FIG. 3C.

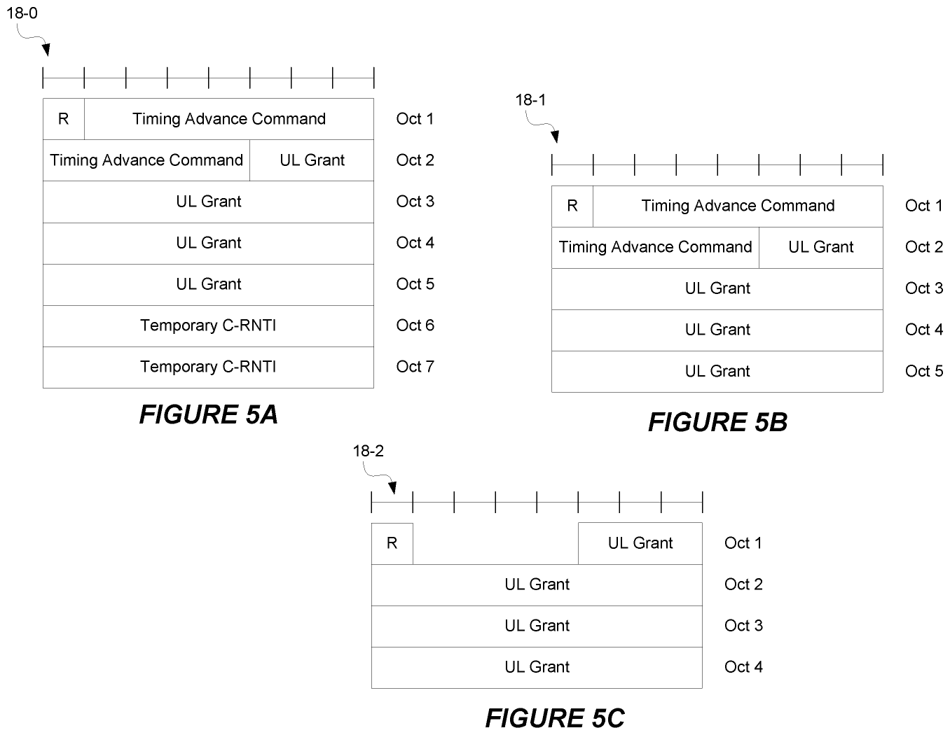

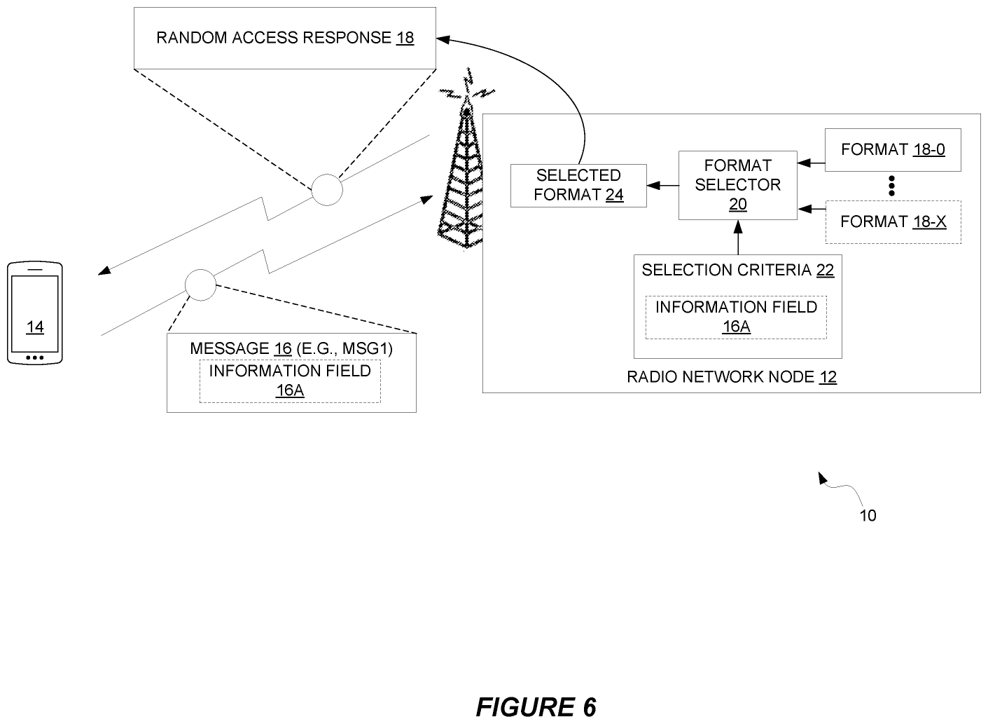

FIGS. 5A-5C by contrast show an example of different candidate formats of a random access response (e.g., MsgB) that takes the form of a fallback response in a 2-step random access procedure. As shown in FIG. 5A, candidate format 18-0 has a size of 7 octets and includes 1 reserved bit, a timing advance command (TAC) field, an uplink (UL) grant field, and a temporary Cell Radio Network Temporary Identifier (C-RNTI) field. The reserved bit is set to 0. By contrast, candidate format 18-1 shown in FIG. 5B has a size of only 5 octets and includes the same fields as format 18-0 in FIG. 5A except for the temporary C-RNTI field, i.e., format 18-1 lacks a temporary C-RNTI field. Further contrasted, candidate format 18-2 shown in FIG. 5C has a size of 4 octets and includes the same fields as format 18-0 in FIG. 5A except for the temporary C-RNTI field and the TAC field, i.e., format 18-2 lacks a temporary C-RNTI field and a TAC field.

In some embodiments, format 18-0 in FIG. 5A is specific for the same scenario(s) as those described above for format 18-0 in FIG. 3A, format 18-1 in FIG. 5B is specific for the same scenario(s) as those described above for format 18-1 in FIG. 3B, and format 18-2 in FIG. 5C is specific for the same scenario(s) as those described above for format 18-3 in FIG. 3C.

As demonstrated with the above examples, then, the radio network node 12 in some embodiments may select the format of the random access response 18 to be a first format (e.g., format 18-0) if the wireless device 14 is not in an RRC connected state. And the radio network node 12 may select the format of the random access response 18 to be a second format (e.g., format 18-1 or format 18-2) if the wireless device 14 is in an RRC connected state. Here, the second format is smaller is size than the first format and/or has fewer fields than the first format. Indeed, in the examples above, the first format (e.g., format 18-0) may include a TAC field and a TC-RNTI field, whereas the second format (e.g., format 18-1 or format 18-2) lacks a TAC field and/or a TC-RNTI field. Or, in other examples, the first format may include a TAC field and a C-RNTI field, whereas the second format lacks a TAC field and/or a C-RNTI field. Regardless, the TC-RNTI field and the C-RNTI field are thereby fields that some embodiments exclude from the random access response 18 when the wireless device 14 is in an RRC connected state, e.g., such that some embodiments deem those fields unnecessary in that scenario.

According to some embodiments, for example, the RRC connected state of the wireless device 14 means the radio network node 12 already has a C-RNTI stored for that wireless device 14. In other words, the random access response 18 need not convey such a C-RNTI to the wireless device 14, because the wireless device 14 already has a C-RNTI. Moreover, for any further message of the random access procedure which is encoded based on the C-RNTI allocated to the wireless device 14, the radio network node 12 according to some embodiments blindly decodes that further message. That is, the radio network node 12 blindly decodes the further message using one or more C-RNTIs that are allocated to one or more respective wireless devices that have an RRC connection established with the radio network node 12 (which includes the wireless device 14 when it is in an RRC connected state).

Alternatively or additionally, the radio network node 12 in some embodiments may select the format of the random access response 18 to be a first format (e.g., format 18-0 or format 18-1) if the wireless device 14 does not have a valid timing advance (TA). And the radio network node 12 may select the format of the random access response 18 to be a second format (e.g., format 18-2) if the wireless device 14 does have a valid TA. Here, the second format is smaller is size than the first format and/or has fewer fields than the first format. Indeed, in the examples above, the first format (e.g., format 18-0 or format 18-1) may include a TAC field, whereas the second format (e.g., format 18-2) lacks a TAC field. The TAC field is thereby a field that some embodiments exclude from the random access response 18 when the wireless device 14 already has a valid TA, e.g., such that some embodiments deem the TAC field unnecessary in that scenario where uplink time alignment is still being maintained.

In any event, the selection criteria 22 based on which the radio network node 12 selects a format of the random access response 18 may in some embodiments include or otherwise depend on criteria according to which the different candidate formats 18-0 . . . 18-X are distinguished. Referring to FIG. 2A, for instance, the selection criteria 22 may include or otherwise depend on criteria that indicates which of the scenarios 24-0 . . . 24-X is applicable for the random access response 18. Or, referring to FIG. 2B, the selection criteria 22 may include or otherwise depend on criteria that indicates which of the RA triggering events 24-0 . . . 24-X triggered the random access procedure of which the random access response 18 is a part. Or, referring to FIG. 2C, the selection criteria 22 may include or otherwise depend on criteria that indicates in which of the RRC states 24-0 . . . 24-X the wireless device 14 operates. Or, referring to FIG. 2D, the selection criteria 22 may include or otherwise depend on criteria that indicates which of the TA statuses 24-0 . . . 24-X describes the wireless device 14's TA status. The radio network node 12 may acquire this selection criteria 22 in any number of ways.

In some embodiments, for example, the selection criteria 22 includes or is based on an information field 16A included in the message 16 that the wireless device 14 transmits to the radio network node 12. In one embodiment, the information field 16A explicitly indicates the format of the random access response 18 (e.g., MsgA in 2-step RA) that is to be transmitted as a response to the message 16. In this case, then, the wireless device 14 itself may select the format of the random access response 18 as described herein and explicitly signal the device-selected format to the radio network node 12. In one embodiment, for example, the information field 16A may indicate an index from among multiple different indices mapped to the different candidate formats 18-0 . . . 18-X for the response 18. The information field 16A may be carried in a MAC subheader, a MAC control element (CE), or an RRC signaling message. Regardless, the radio network node 12 may then select the format of the random access response 18 based on the information field 16A, e.g., taking into account the signaled format as a recommendation or preference.

In other embodiments, the information field 16A explicitly indicates other information that is usable as the selection criteria 22 for the radio network node 12 to select the format of the random access response 18. The information field 16A may for example explicitly indicate information such as a triggering event that triggered the procedure for random access, and/or a purpose of the procedure for random access, and/or an RRC state of the wireless device 14, and/or a TA status of the wireless device, and/or any other information that may distinguish according to which scenario 24-0 . . . 24-X random access is being performed, e.g., as described in FIGS. 2A-2D. In this way, the information field 16A may be said to implicitly indicate the format to be used for the random access response 18.

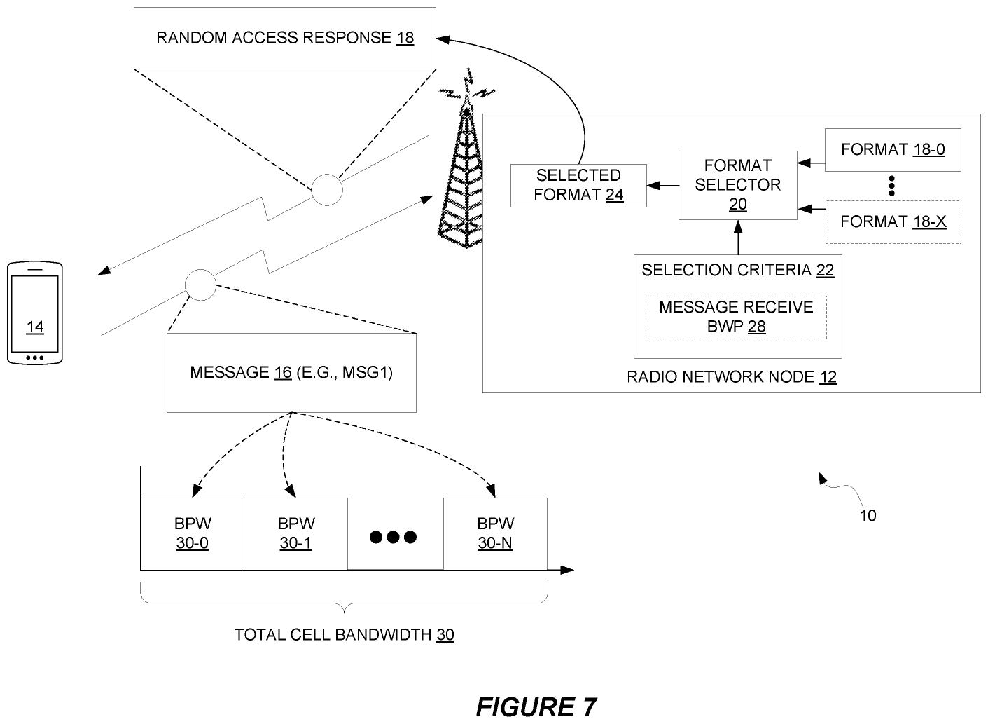

In yet other embodiments shown in FIG. 7, the selection criteria 22 includes an uplink bandwidth part (BWP) of the cell on which the message 16 was received by the radio network node 12, i.e., the message receive BWP 28. More particularly in this regard, the total cell bandwidth 30 of the cell served by the radio network node 12 in some embodiments includes multiple BWPs 30-0, 30-1, . . . 30-N, e.g., that are uplink BWPs dedicated for uplink communication. The BWPs 30-0, 30-1., 30-N may be included within the frequency span of the same carrier, e.g., to accommodate different types of wireless devices that have different capabilities in terms of the bandwidth they support. In some embodiments, the BWPs 30-0, 30-1, . . . 30-N are non-overlapping, whereas in other embodiments the BWPs may at least partially overlap with one another. Regardless, the radio network node 12 according to some embodiments may select a format of the random access response 18 as a function of on which uplink BWP 30-0, 30-1, . . . 30-N of the cell the message 16 was received.

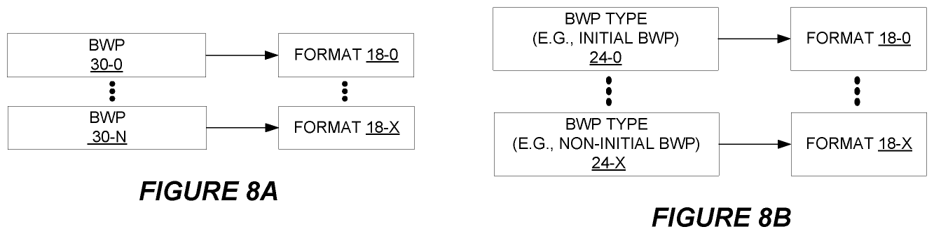

FIG. 8A for example shows that in some embodiments at least some different uplink BWPs 30-0 . . . 30-N are associated with different candidate formats 18-0 . . . 18-X for the random access response 18. This association may be on a one-to-one basis, a many-to-one basis, or a one-to-many basis. As an example of a one-to-many basis, BWP 30-0 may be associated with format 18-0 and other BWPs besides BWP 30-0 may each be associated with format 18-X. In this case, then the radio network node 12 would select format 18-0 if the message 16 is received on BWP 30-0 and would select a format other than format 18-0 if the message 16 is received on a BWP other than BWP 30-0.

FIG. 8B shows another example. In this example, different types of uplink BWPs 30-0 . . . 30-N are associated with different respective candidate formats 18-0 . . . 18-X for the random access response 18. Types of uplink BWPs may for instance include an initial uplink BWP and a non-initial uplink BWP, where an initial uplink BWP is an uplink BWP that a wireless device is to use during initial access to the cell until the wireless device is configured with a non-initial uplink BWP. In some embodiments, there can only be one active uplink BWP for a wireless device at a time. The initial uplink BWP may for instance be indicated in broadcast signaling transmitted by the radio network node 12, e.g., as part of a System Information Block (SIB). Regardless, an initial BWP may be associated with format 18-0 and non-initial uplink BWPs may each be associated with format 18-X. In this case, then the radio network node 12 would select format 18-0 if the message 16 is received on an initial BWP and would select a format 18-X other than format 18-0 if the message 16 is received on a non-initial BWP. In some embodiments, this other format 18-X may be smaller in size than the first format 18-0 and/or have fewer fields than the first format 18-0. Generally, though, the radio network node 12 may select the format of the random access response 18 as a function of whether an uplink BWP on which the message 16 was received is an initial uplink BWP or a non-initial uplink BWP. For example, the radio network node 12 may select the format to be a first format (e.g., format 18-0) if the message 16 was received on an initial uplink BWP and select the format to be a second format (e.g., format 18-X) if the message 16 was received on a non-initial uplink BWP.

In some embodiments, a wireless device must be in RRC connected mode in order to perform random access on a non-initial uplink BWP, i.e., when the wireless device's active uplink BWP is different from the initial uplink BWP. In these embodiments, then, receipt by the radio network node 12 of the message 16 on a non-initial uplink BWP may indicate that the wireless device 14 is in RRC connected mode, whereas receipt of the message 16 on the initial uplink BWP may indicate that the wireless device 14 is in an RRC idle mode or an RRC inactive mode. Accordingly, when the radio network node 12 receives the message 16 on a non-initial uplink BWP, the radio network node 12 in some embodiments selects a candidate format (e.g., in FIG. 3B or 3C) that is specific for a scenario where the wireless device 14 is in an RRC connected state. And when the radio network node 12 receives the message 16 on an initial uplink BWP, the radio network node 12 selects a candidate format (e.g., in FIG. 3A) that is specific for a scenario where the wireless device 14 is in an RRC idle state.

Similarly, in some embodiments, different events trigger random access on respective types of uplink BWPs, such that the type of uplink BWP on which the message 16 is received reveals information about which type of event triggered the random access. In these embodiments, then, receipt by the radio network node 12 of the message 16 on a non-initial uplink BWP may indicate that the random access was triggered by an event in a set of candidate event(s), whereas receipt of the message 16 on the initial uplink BWP may indicate that the random access was triggered by an event in a different set of candidate event(s). Accordingly, when the radio network node 12 receives the message 16 on a non-initial uplink BWP, the radio network node 12 in some embodiments selects a candidate format (e.g., in FIG. 3B or 3C) that is specific for a certain set of candidate event(s). And when the radio network node 12 receives the message 16 on an initial uplink BWP, the radio network node 12 selects a candidate format (e.g., in FIG. 3A) that is specific for a different set of candidate event(s). For example, based on receiving the message 16 on a non-initial uplink BWP of a cell served by the radio network node 12, the radio network node 12 transmits a random access response 18 that lacks a C-RNTI field (or lacks a TC-RNTI field), i.e., the format selected for the random access response 18 lacks such a field. On the other hand, based on receiving the message 16 on an initial uplink BWP of a cell served by the radio network node 12, the radio network node 12 transmits a random access response 18 that has a C-RNTI field (or has a TC-RNTI field), i.e., the format selected for the random access response 18 has such a field.

Generally, then, different types of uplink BWPs of the cell may be associated with different random access response formats, and/or different RRC states, and/or different random access trigger events, e.g., such that the uplink BWP used for random access implicitly signals the format for the response 18, and/or the wireless device's RRC state, and/or the random access triggering event. Accordingly, with the selection criteria 22 for format selection including on which type of uplink BWP the message 16 was received, the radio network node 12 may effectively select the format for the random access response 18 based on or depending on the wireless device's RRC state or the triggering event which triggered the random access. Note, though, that the selection criteria 22 in some embodiments may be directly specified in terms of on which uplink BWP the message 16 was received. By contrast, in other embodiments, the selection criteria 22 may be specified in terms of the wireless device's RRC state or the random access triggering event, but the radio network node 12 determines the RRC state and/or the triggering event as a function of on which uplink BWP the message 16 was received.

In still other embodiments, the radio network node 12 may select the format of the random access response 18 additionally or alternatively as a function of which random access preamble is included in the message 16. In this case, different sets of random access preambles may be associated with different random access formats, and/or different RRC states, and/or different random access triggering events. The random access preamble may thereby implicitly signal the format for the response 18, and/or the wireless device's RRC state, and/or the random access triggering event.

In yet other embodiments, the radio network node 12 may select the format of the random access response 18 additionally or alternatively as a function of on which random access resource the message 16 is received. A random access resource may for example be a time-frequency resource. In this case, different sets of random access resources may be associated with different random access formats, and/or different RRC states, and/or different random access triggering events. The random access resource used for random access may thereby implicitly signal the format for the response 18, and/or the wireless device's RRC state, and/or the random access triggering event.

In some embodiments, the radio network node 12 may select the format of the random access response 18 additionally or alternatively as a function of a radio coverage level of the wireless device 14. For example, the wireless device 14 may measure its radio coverage level (e.g., in terms of a Reference Signal Received Power, RSRP) and signal the measured level to the radio network node 12. The radio network node 12 may use the received level measurement as selection criteria 22 for selecting the format of the random access response 18. For example, the radio network node 12 may unconditionally select a certain format (e.g., a default format with all possible fields) if the wireless device 14 has a radio coverage level above a threshold. In good coverage, the size of the random access response 18 is not as important as it is in bad coverage. On the other hand, then, the radio network node 12 may select another format (e.g., a smaller format with fewer fields) as described above, if the wireless device 14 has a radio coverage level below the threshold. That is, some embodiments for format selection herein are selectively applicable when coverage levels are below a threshold.

Similarly, the radio network node 12 may select the format of the random access response 18 additionally or alternatively as a function of a subcarrier spacing (SCS) used for the random access procedure. For example, relatively higher SCS may be selectively usable in relatively good coverage levels whereas relatively lower SCS may be selectively usable in relatively bad coverage levels. The radio network node 12 may therefore use the SCS as selection criteria 22 for selecting the format of the random access response 18 in a similar way as described above for coverage level. For example, the radio network node 12 may unconditionally select a certain format (e.g., a default format with all possible fields) if a SCS less than a threshold is used for random access. On the other hand, the radio network node 12 may select another format (e.g., a smaller format with fewer fields) as described above, if a SCS above the same or a different threshold is used for random access. That is, some embodiments for format selection herein are selectively applicable when SCS is above a threshold.

No matter how the radio network node 18 selects the format of the random access response 18, the radio network node 18 thereafter transmits the random access response 18 with the selected format 24. In some embodiments, the wireless device 14 blindly decodes the random access response 18 using the different candidate formats 18-0 . . . 18-X. In other embodiments, the random access response 18 includes a field which indicates a format of the random access response 18. In still other embodiments, the wireless device 14 is preconfigured with which format to use for decoding of the random access response 18. For example, the radio network node 12 may configure the wireless device 14 to use one format or the other, e.g., using RRC dedicated signaling. Or, the radio network node 12 may signal the format to use for decoding of the random access response 18 via System Information. In these and other embodiments, the wireless device 14 may transmit capability signaling indicating whether or not the wireless device 14 supports a certain random access response format.

Note that embodiments herein are applicable to any type of random access procedure.

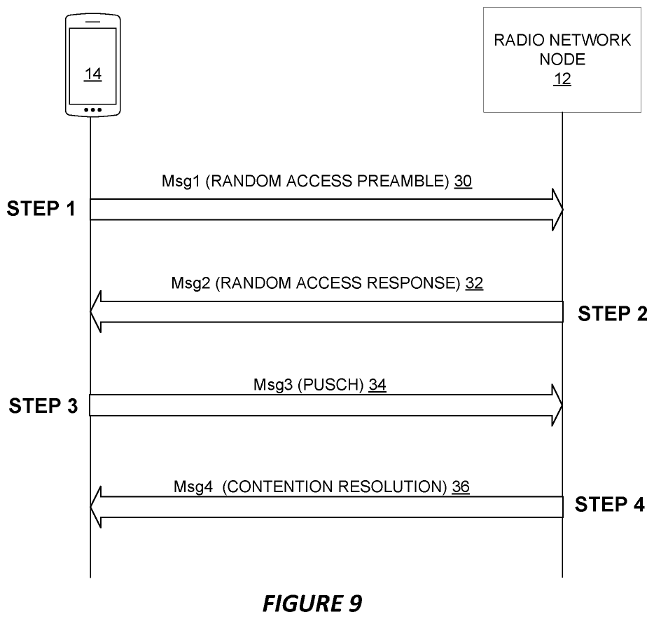

FIG. 9 for example shows a 4-step random access procedure according to some embodiments. As part of this procedure, the wireless communication device 14 transmits a random access preamble 30 in Msg1 (Step 1). The random access preamble 30 may be transmitted on a Physical Random Access Channel (PRACH). Msg1 is one example of the message 16 in FIG. 1. In response to Msg1, the radio network node 12 replies with a random access response 32 (RAR) referred to as Msg2 (Step 2). Msg2 is one example of the random access response 18 in FIG. 1. The radio network node 12 in this case selects a format of the RAR 32 according to embodiments herein. In one embodiment, the RAR message is included in a Medium Access Control (MAC) Protocol Data Unit (PDU) (also referred to as a MAC transport block). In this case, the MAC PDU may include a MAC PDU subheader that corresponds to the included RAR message. The MAC PDU subheader may include a field that indicates a random access preamble (RAP) identity (RAPID) identifying the random access preamble, e.g., so as to indicate that the corresponding RAR message is a response to the identified random access preamble.

Responsive to receiving Msg2, the wireless communication device 14 transmits to the radio network node 12 a message referred to as Msg3 34, e.g., on a Physical Uplink Shared Channel (PUSCH) (Step 3). Msg3 may be include or convey a so-called contention resolution identity, e.g., for resolving any contention with another wireless communication device that may have selected the same random access preamble 30. Msg3 may also include a Radio Resource Control (RRC) connection establishment or resume request. Note that the wireless communication device 14 transmits Msg3 34 using the uplink grant and timing advance command provided in Msg2 according to some RAR formats. The timing advance command allows the PUSCH to be received with a timing accuracy within a cyclic prefix (CP) of Msg3. Without this timing advance, a very large CP would be needed in order for the radio network node 12 to demodulate and detect the PUSCH, unless there is a very small distance between the radio network node 12 and the wireless communication device 14.

Finally, in response to Msg3, the radio network node 12 may transmit to the wireless communication device 14, a message referred to as Msg4 36 (Step 4). Msg4 may include a contention resolution identity (e.g., as received in Msg3) in order to resolve contention. Msg4 may also include an RRC connection setup or resume message for setting up or resuming an RRC connection.

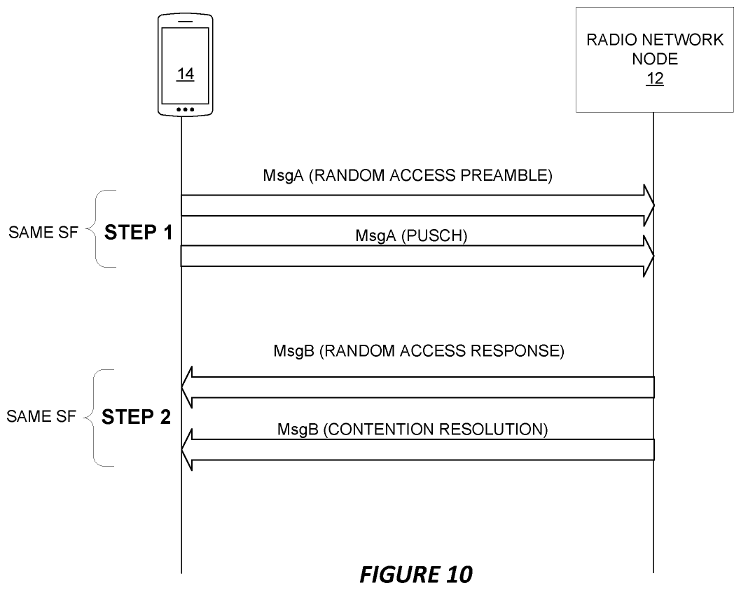

FIG. 10 by contrast shows the 2-step random access procedure. The random access procedure as shown includes two steps, e.g., as opposed to the conventional 4 steps. In the first step, the wireless communication device 14 performs a transmission on a random access channel (RACH) and an uplink shared channel (e.g., a physical uplink shared channel, PUSCH). This transmission may be referred to as MsgA. The transmission on the RACH conveys the random access preamble 30. The transmission on the uplink shared channel may convey an RRC establishment request or RRC resume request. The transmission on the RACH and the transmission on the uplink shared channel may be performed in the same subframe, or in successive subframes, e.g., such that the transmission on the uplink shared channel is performed before any response is received to the transmission on the RACH. MsgA is one example of the message 16 in FIG. 1.

In the second step, the radio network node 12 transmits a response to MsgA and uplink shared channel transmission. If the radio network node 12 successfully decoded the RACH and the uplink shared channel payload, the radio network node 12 transmits a random access success response message (also referred to as a random access success response, or simply, success response). This random access success response message correspondingly indicates that both the RACH and the uplink shared channel payload were decoded successfully. Note in this regard that, unlike the traditional 4-step procedure, the random access success response is transmitted as a response to both the RACH and the uplink shared channel transmission.

In any event, the radio network node 12 in some embodiments conveys this random access success response message within or as a transmission referred to as MsgB. In one or more embodiment, for instance, the random access success response message is included in a medium access control (MAC) protocol data unit (PDU). MsgB is one example of the random access response 18 in FIG. 1. The radio network node 12 may select a format of the random access success response message according to embodiments herein. Note though that MsgB may contain responses to multiple wireless communication devices, with different kinds of information for different wireless communication devices depending on the outcome of the MsgA transmission/reception.

In some embodiments, Msg1 or MsgA in FIGS. 9 and 10 may be transmitted on one of multiple BWPs of a cell. In one embodiment, each BWP is a contiguous subset of physical resource blocks (PRBs) defined for a given numerology on a given carrier, e.g., where a PRB is 12 consecutive subcarriers in the frequency domain. Although illustrated herein as non-overlapping or disjoint, the BWPs in other embodiments may at least partially overlap with one another.

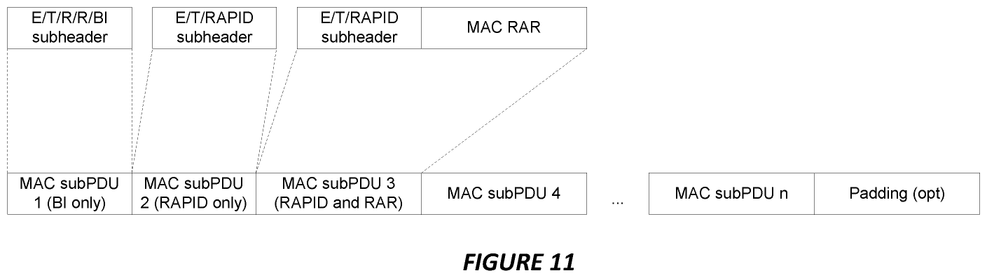

FIG. 11 illustrates additional details of a random access response 18 defined at a Medium Access Control (MAC) layer according to some embodiments. As shown, a MAC

PDU consists of one or more MAC subPDUs and optionally padding. Each MAC subPDU consists one of the following (i) a MAC subheader with Backoff Indicator (BI) only, (ii) a MAC subheader with RAPID only (i.e. acknowledgment for SI request), or (iii) MAC subheader with RAPID and MAC random access response (RAR). This MAC RAR is one example of a random access response 18 as described herein.

Note further that random access herein may be performed in any number of possible RRC states. An RRC idle state herein is a state in which the wireless device 14 has no RRC connection established. In the RRC idle state, the wireless device 14 may acquire system information, monitor a paging channel for core network paging, and/or perform neighbor cell measurements and cell (re)selection. An RRC inactive state herein is a state in which the wireless device has an RRC connection established, but the RRC connection is suspended. In the RRC inactive state, the wireless device 14 may store a context for the suspended RRC connection, acquire system information, monitoring a paging channel for core network paging and/or radio access network (RAN) paging, perform neighbor cell measurements and cell (re)selection, and/or perform RAN-based notification area updates. By storing the context for the suspended RRC connection, the wireless device 14 can resume the RRC connection more quickly than if the wireless device 14 had released the context as in RRC idle state. If inactivity continues for longer than a certain time, the wireless device 14 may only then release its RRC connection with the access network and transition to RRC idle state. On the other hand, if the wireless device 14 becomes active, the wireless device 14 may transition to an RRC connected state in order to establish or resume an RRC connection.

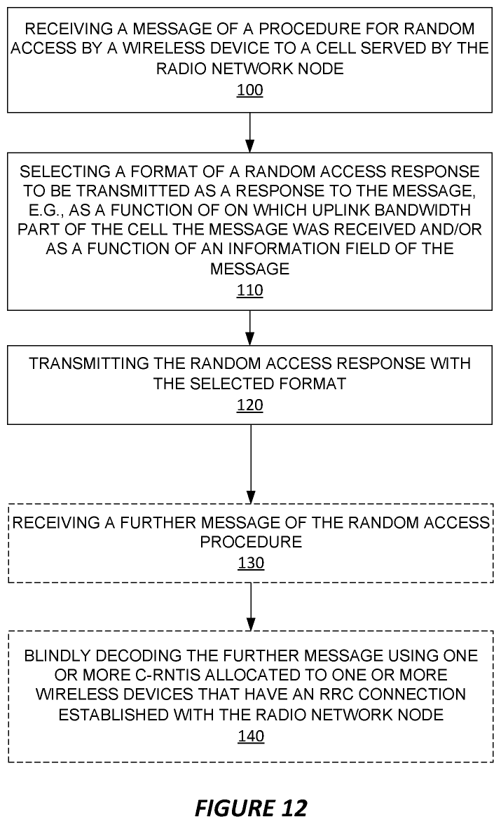

In view of the above modifications and variations, FIG. 12 depicts a method performed by a radio network node 12 configured for use in a wireless communication network 10 according to some embodiments. As shown, the method comprises receiving a message 16 of a procedure for random access by a wireless device 14 to a cell served by the radio network node 12 (Block 100). The method also comprises selecting a format 24 of a random access response 18 to be transmitted as a response to the message 16 (Block 110). The method further comprises transmitting the random access response 18 with the selected format 24 (Block 120).

In some embodiments, for example, the format 24 may be selected from among different candidate formats 18-0 . . . 18-X that have different sizes and/or at least some different fields. For example, at least one of the candidate formats 18-0 . . . 18-X may include a timing advance command, TAC, field and a Temporary Cell Radio Network Temporary Identifier, TC-RNTI, field. And at least one other of the candidate formats 18-0 . . . 18-X may lack a TAC field and/or a TC-RNTI.

In some embodiments, the format 24 is selected in Block 110 as a function of on which uplink bandwidth part 30-0 . . . 30-N of the cell the message 16 was received. For example, different types of uplink bandwidth parts of the cell may be associated with different random access response formats. Where the different types of uplink bandwidth parts include an initial uplink bandwidth part and a non-initial uplink bandwidth part, the format 24 may be selected as a function of whether an uplink bandwidth part on which the message 16 was received is an initial uplink bandwidth part or a non-initial uplink bandwidth part. Alternatively or additionally, the format 24 may be selected to be a first format or a second format depending respectively on whether an uplink bandwidth part on which the message 16 was received is an initial uplink bandwidth part or a non-initial uplink bandwidth part. In this case, the second format may be smaller in size than the first format and/or may have fewer fields than the first format.

Alternatively or additionally, the format 24 in some embodiments may be selected as a function of an information field 16A of the message 16. The information field 16A may for example explicitly indicate either a format of the random access response 18 to be transmitted, or a Radio Resource Control state of the wireless device 14, or a triggering event that triggered the procedure for random access. In the case that the information field 16A indicates an RRC state of the wireless device 14, the format 24 may be selected to be a first format or a second format depending respectively on whether the information field 16A indicates the wireless device 14 is not or is in an RRC Connected state, e.g., the second format is smaller in size than the first format and/or has fewer fields than the first format.

Regardless, the method as shown in some embodiments also comprises, after transmitting the random access response 18, receiving a further message of the random access procedure (Block 130). The method in this case may further comprise blindly decoding the further message using one or more Cell Radio Network Temporary Identifiers, C-RNTIs, allocated to one or more wireless devices that have a Radio Resource Control, RRC, connection established with the radio network node 12 (Block 140). Such blind decoding may be performed for instance based on having selected the format 24 of the random access response 18 to be a format that lacks a Temporary Cell Radio Network Temporary Identifier, TC-RNTI, field.

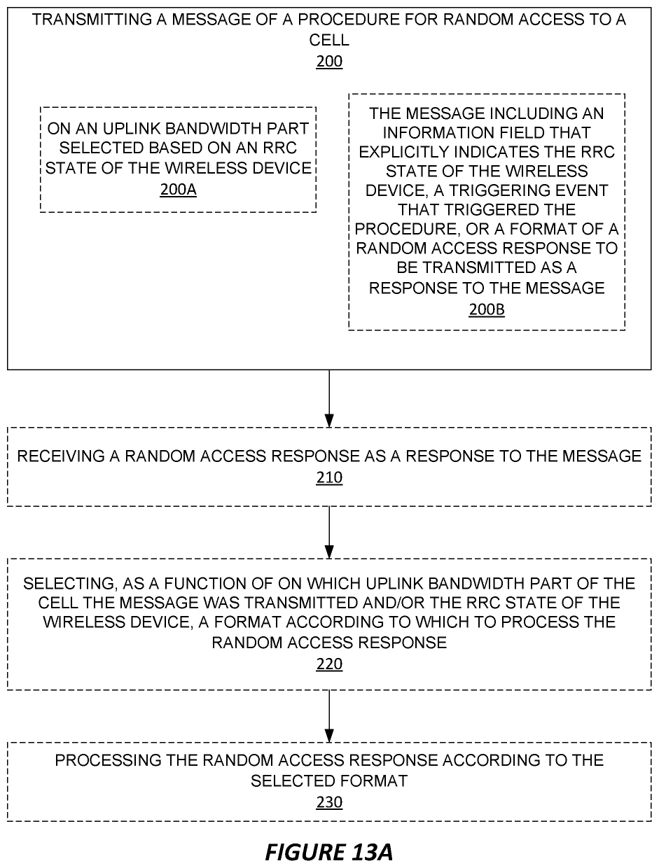

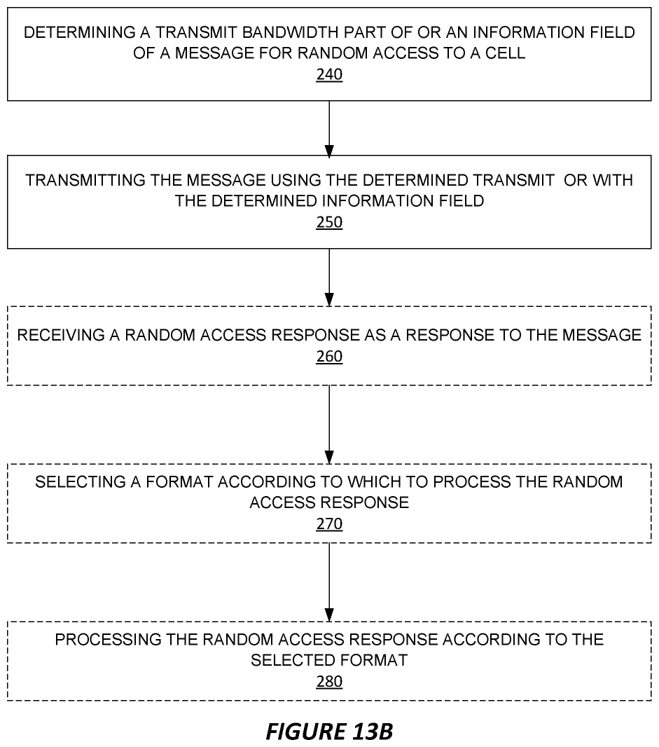

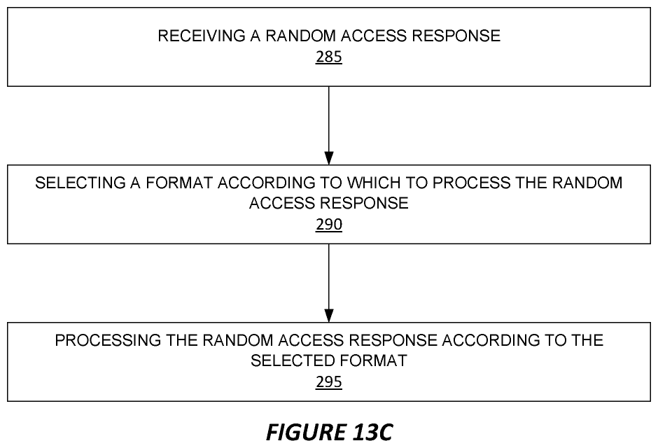

FIG. 13A depicts a method performed by a wireless device 14 configured for use in a wireless communication network 10 according to some embodiments. As shown, the method comprises transmitting a message 16 of a procedure for random access to a cell (Block 200). In some embodiments, the message 16 is transmitted on an uplink bandwidth part selected based on a Radio Resource Control, RRC, state of the wireless device 14 (Block 200A). Alternatively or additionally, the message 16 includes an information field 16A that explicitly indicates the RRC state of the wireless device 14, or a triggering event that triggered the procedure, or a format of a random access response 18 to be transmitted as a response to the message 16 (Block 200B).

Where the message 16 is transmitted on an uplink bandwidth part selected based on a Radio Resource Control, RRC, state of the wireless device 14, for example, the method may further comprise selecting, based on the RRC state of the wireless device 14, the uplink bandwidth part on which to transmit the message 16 (Step not shown). The method may also comprise transmitting the message on the selected uplink bandwidth part.

Regardless, in some embodiments the method further comprises receiving a random access response 18 as a response to the message 16 (Block 210). The method may also comprise selecting, as a function of on which uplink bandwidth part of the cell the message 16 was transmitted and/or the RRC state of the wireless device 14, a format according to which to process the random access response 18 (Block 220). The format may be selected for example from among different candidate formats that have different sizes and/or at least some different fields. For example, at least one of the candidate formats 18-0 . . . 18-X may include a timing advance command, TAC, field and a Temporary Cell Radio Network Temporary Identifier, TC-RNTI, field. And at least one other of the candidate formats 18-0 . . . 18-X may lack a TAC field and/or a TC-RNTI. Regardless, the method may then include processing the random access response 18 according to the selected format (Block 230).

FIG. 13B shows a method performed by a wireless device 14 configured for use in a wireless communication network 10 according to other embodiments. As shown, the method comprises determining a transmit bandwidth part of or an information field 16A of a message 16 for random access to a cell (Block 240). Here, the transmit bandwidth part of the message 16 is an uplink bandwidth part on which the message 16 is to be transmitted. In some embodiments, the transmit bandwidth part is determined as a function an RRC state of the wireless device 14, a triggering event that triggered the procedure, or a format of a random access response 18 to be transmitted as a response to the message 16. In this case, then, the uplink bandwidth part on which the message 16 is to be transmitted is to implicitly indicate the RRC state of the wireless device 14, the triggering event that triggered the procedure, or the format of a random access response 18 to be transmitted as a response to the message 16. In other embodiments, the information field 16A is determined to explicitly indicate an RRC state of the wireless device 14, a triggering event that triggered the procedure, or a format of a random access response 18 to be transmitted as a response to the message 16. Regardless, the method as shown further comprises transmitting the message 16 using the determined transmit bandwidth part or with the determined information field 16A.

Where the message 16 is transmitted on an uplink bandwidth part selected based on a Radio Resource Control, RRC, state of the wireless device 14, for example, the method may further comprise selecting, based on the RRC state of the wireless device 14, the uplink bandwidth part on which to transmit the message 16 (Step not shown). The method may also comprise transmitting the message 16 on the selected uplink bandwidth part.

Regardless, in some embodiments the method further comprises receiving a random access response 18 as a response to the message 16 (Block 260). The method may also comprise selecting, as a function of on which uplink bandwidth part of the cell the message 16 was transmitted and/or the RRC state of the wireless device 14, a format according to which to process the random access response 18 (Block 270). The format may be selected for example from among different candidate formats that have different sizes and/or at least some different fields. For example, at least one of the candidate formats 18-0 . . . 18-X may include a timing advance command, TAC, field and a Temporary Cell Radio Network Temporary Identifier, TC-RNTI, field. And at least one other of the candidate formats 18-0 . . . 18-X may lack a TAC field and/or a TC-RNTI. Regardless, the method may then include processing the random access response 18 according to the selected format (Block 280).

FIG. 13C shows a method performed by a wireless device 14 configured for use in a wireless communication network 10 according to still other embodiments. As shown, the method comprises receiving a random access response 18 as a response to a message 16 of a procedure for random access to a cell (Block 285). The method also comprises selecting a format 24 according to which to process the random access response (Block 290). The format 24 may be selected as a function of an uplink bandwidth part on which the message 16 was transmitted, an RRC state of the wireless device 14, and/or a triggering event that triggered the procedure. Regardless, the method further comprises processing the random access response 18 according to the selected format (Block 295).

The format may be selected for example from among different candidate formats that have different sizes and/or at least some different fields. For example, at least one of the candidate formats 18-0 . . . 18-X may include a timing advance command, TAC, field and a Temporary Cell Radio Network Temporary Identifier, TC-RNTI, field. And at least one other of the candidate formats 18-0 . . . 18-X may lack a TAC field and/or a TC-RNTI.

Embodiments herein also include corresponding apparatuses. Embodiments herein for instance include a wireless device 14 configured to perform any of the steps of any of the embodiments described above for the wireless device 14.

Embodiments also include a wireless device 14 comprising processing circuitry and power supply circuitry. The processing circuitry is configured to perform any of the steps of any of the embodiments described above for the wireless device 14. The power supply circuitry is configured to supply power to the wireless device 14.

Embodiments further include a wireless device comprising processing circuitry. The processing circuitry is configured to perform any of the steps of any of the embodiments described above for the wireless device 14. In some embodiments, the wireless device 14 further comprises communication circuitry.

Embodiments further include a wireless device 14 comprising processing circuitry and memory. The memory contains instructions executable by the processing circuitry whereby the wireless device 14 is configured to perform any of the steps of any of the embodiments described above for the wireless device 14.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless device 14. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a radio network node 12 configured to perform any of the steps of any of the embodiments described above for the radio network node 12.

Embodiments also include a radio network node 12 comprising processing circuitry and power supply circuitry. The processing circuitry is configured to perform any of the steps of any of the embodiments described above for the radio network node 12. The power supply circuitry is configured to supply power to the radio network node 12.

Embodiments further include a radio network node 12 comprising processing circuitry. The processing circuitry is configured to perform any of the steps of any of the embodiments described above for the radio network node 12. In some embodiments, the radio network node 12 further comprises communication circuitry.

Embodiments further include a radio network node 12 comprising processing circuitry and memory. The memory contains instructions executable by the processing circuitry whereby the radio network node 12 is configured to perform any of the steps of any of the embodiments described above for the radio network node 12.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

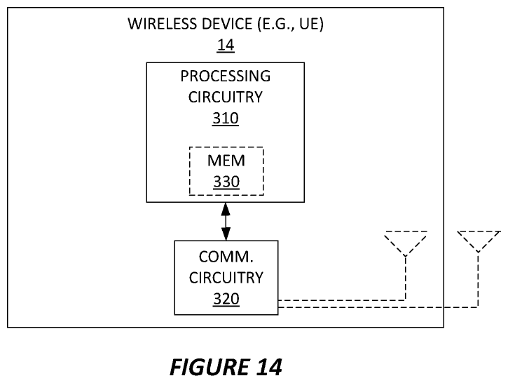

FIG. 14 for example illustrates a wireless device 14 as implemented in accordance with one or more embodiments. As shown, the wireless device 14 includes processing circuitry 310 and communication circuitry 320. The communication circuitry 320 (e.g., radio circuitry) is configured to transmit and/or receive information to and/or from one or more other nodes, e.g., via any communication technology. Such communication may occur via one or more antennas that are either internal or external to the wireless device 14. The processing circuitry 310 is configured to perform processing described above, e.g., in FIG. 13, such as by executing instructions stored in memory 330. The processing circuitry 310 in this regard may implement certain functional means, units, or modules.

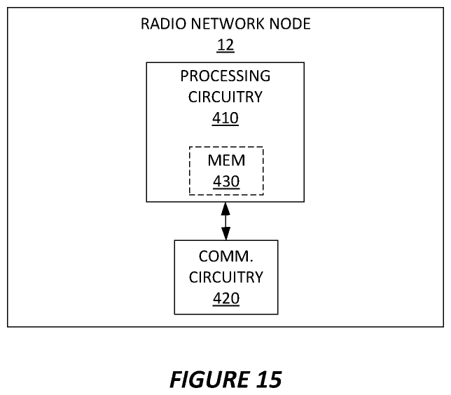

FIG. 15 illustrates a radio network node 12 as implemented in accordance with one or more embodiments. As shown, the radio network node 12 includes processing circuitry 410 and communication circuitry 420. The communication circuitry 420 is configured to transmit and/or receive information to and/or from one or more other nodes, e.g., via any communication technology. The processing circuitry 410 is configured to perform processing described above, e.g., in FIG. 12, such as by executing instructions stored in memory 430. The processing circuitry 410 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

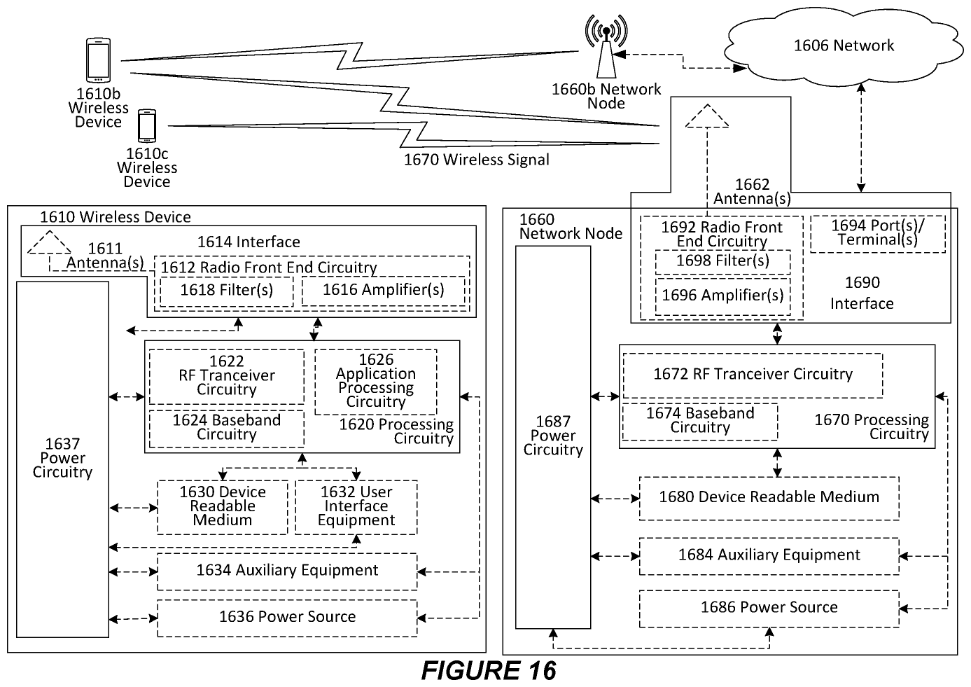

Although the subject matter described herein may be implemented in any appropriate type of system using any suitable components, the embodiments disclosed herein are described in relation to a wireless network, such as the example wireless network illustrated in FIG. 16. For simplicity, the wireless network of FIG. 16 only depicts network 1606, network nodes 1660 and 1660b, and WDs 1610, 1610b, and 1610c. In practice, a wireless network may further include any additional elements suitable to support communication between wireless devices or between a wireless device and another communication device, such as a landline telephone, a service provider, or any other network node or end device. Of the illustrated components, network node 1660 and wireless device (WD) 1610 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1606 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1660 and WD 1610 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 16, network node 1660 includes processing circuitry 1670, device readable medium 1680, interface 1690, auxiliary equipment 1684, power source 1686, power circuitry 1687, and antenna 1662. Although network node 1660 illustrated in the example wireless network of FIG. 16 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1660 are depicted as single boxes located within a larger box, or nested within multiple boxes, in practice, a network node may comprise multiple different physical components that make up a single illustrated component (e.g., device readable medium 1680 may comprise multiple separate hard drives as well as multiple RAM modules).

Similarly, network node 1660 may be composed of multiple physically separate components (e.g., a NodeB component and a RNC component, or a BTS component and a BSC component, etc.), which may each have their own respective components. In certain scenarios in which network node 1660 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1660 may be configured to support multiple radio access technologies (RATs). In such embodiments, some components may be duplicated (e.g., separate device readable medium 1680 for the different RATs) and some components may be reused (e.g., the same antenna 1662 may be shared by the RATs). Network node 1660 may also include multiple sets of the various illustrated components for different wireless technologies integrated into network node 1660, such as, for example, GSM, WCDMA, LTE, NR, WiFi, or Bluetooth wireless technologies. These wireless technologies may be integrated into the same or different chip or set of chips and other components within network node 1660.

Processing circuitry 1670 is configured to perform any determining, calculating, or similar operations (e.g., certain obtaining operations) described herein as being provided by a network node. These operations performed by processing circuitry 1670 may include processing information obtained by processing circuitry 1670 by, for example, converting the obtained information into other information, comparing the obtained information or converted information to information stored in the network node, and/or performing one or more operations based on the obtained information or converted information, and as a result of said processing making a determination.

Processing circuitry 1670 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1660 components, such as device readable medium 1680, network node 1660 functionality. For example, processing circuitry 1670 may execute instructions stored in device readable medium 1680 or in memory within processing circuitry 1670. Such functionality may include providing any of the various wireless features, functions, or benefits discussed herein. In some embodiments, processing circuitry 1670 may include a system on a chip (SOC).

In some embodiments, processing circuitry 1670 may include one or more of radio frequency (RF) transceiver circuitry 1672 and baseband processing circuitry 1674. In some embodiments, radio frequency (RF) transceiver circuitry 1672 and baseband processing circuitry 1674 may be on separate chips (or sets of chips), boards, or units, such as radio units and digital units. In alternative embodiments, part or all of RF transceiver circuitry 1672 and baseband processing circuitry 1674 may be on the same chip or set of chips, boards, or units

In certain embodiments, some or all of the functionality described herein as being provided by a network node, base station, eNB or other such network device may be performed by processing circuitry 1670 executing instructions stored on device readable medium 1680 or memory within processing circuitry 1670. In alternative embodiments, some or all of the functionality may be provided by processing circuitry 1670 without executing instructions stored on a separate or discrete device readable medium, such as in a hard-wired manner. In any of those embodiments, whether executing instructions stored on a device readable storage medium or not, processing circuitry 1670 can be configured to perform the described functionality. The benefits provided by such functionality are not limited to processing circuitry 1670 alone or to other components of network node 1660, but are enjoyed by network node 1660 as a whole, and/or by end users and the wireless network generally.

Device readable medium 1680 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1670. Device readable medium 1680 may store any suitable instructions, data or information, including a computer program, software, an application including one or more of logic, rules, code, tables, etc. and/or other instructions capable of being executed by processing circuitry 1670 and, utilized by network node 1660. Device readable medium 1680 may be used to store any calculations made by processing circuitry 1670 and/or any data received via interface 1690. In some embodiments, processing circuitry 1670 and device readable medium 1680 may be considered to be integrated.

Interface 1690 is used in the wired or wireless communication of signalling and/or data between network node 1660, network 1606, and/or WDs 1610. As illustrated, interface 1690 comprises port(s)/terminal(s) 1694 to send and receive data, for example to and from network 1606 over a wired connection. Interface 1690 also includes radio front end circuitry 1692 that may be coupled to, or in certain embodiments a part of, antenna 1662. Radio front end circuitry 1692 comprises filters 1698 and amplifiers 1696. Radio front end circuitry 1692 may be connected to antenna 1662 and processing circuitry 1670. Radio front end circuitry may be configured to condition signals communicated between antenna 1662 and processing circuitry 1670. Radio front end circuitry 1692 may receive digital data that is to be sent out to other network nodes or WDs via a wireless connection. Radio front end circuitry 1692 may convert the digital data into a radio signal having the appropriate channel and bandwidth parameters using a combination of filters 1698 and/or amplifiers 1696. The radio signal may then be transmitted via antenna 1662. Similarly, when receiving data, antenna 1662 may collect radio signals which are then converted into digital data by radio front end circuitry 1692. The digital data may be passed to processing circuitry 1670. In other embodiments, the interface may comprise different components and/or different combinations of components.

In certain alternative embodiments, network node 1660 may not include separate radio front end circuitry 1692, instead, processing circuitry 1670 may comprise radio front end circuitry and may be connected to antenna 1662 without separate radio front end circuitry 1692. Similarly, in some embodiments, all or some of RF transceiver circuitry 1672 may be considered a part of interface 1690. In still other embodiments, interface 1690 may include one or more ports or terminals 1694, radio front end circuitry 1692, and RF transceiver circuitry 1672, as part of a radio unit (not shown), and interface 1690 may communicate with baseband processing circuitry 1674, which is part of a digital unit (not shown).

Antenna 1662 may include one or more antennas, or antenna arrays, configured to send and/or receive wireless signals. Antenna 1662 may be coupled to radio front end circuitry 1690 and may be any type of antenna capable of transmitting and receiving data and/or signals wirelessly. In some embodiments, antenna 1662 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1662 may be separate from network node 1660 and may be connectable to network node 1660 through an interface or port.

Antenna 1662, interface 1690, and/or processing circuitry 1670 may be configured to perform any receiving operations and/or certain obtaining operations described herein as being performed by a network node. Any information, data and/or signals may be received from a wireless device, another network node and/or any other network equipment. Similarly, antenna 1662, interface 1690, and/or processing circuitry 1670 may be configured to perform any transmitting operations described herein as being performed by a network node. Any information, data and/or signals may be transmitted to a wireless device, another network node and/or any other network equipment.

Power circuitry 1687 may comprise, or be coupled to, power management circuitry and is configured to supply the components of network node 1660 with power for performing the functionality described herein. Power circuitry 1687 may receive power from power source 1686. Power source 1686 and/or power circuitry 1687 may be configured to provide power to the various components of network node 1660 in a form suitable for the respective components (e.g., at a voltage and current level needed for each respective component). Power source 1686 may either be included in, or external to, power circuitry 1687 and/or network node 1660. For example, network node 1660 may be connectable to an external power source (e.g., an electricity outlet) via an input circuitry or interface such as an electrical cable, whereby the external power source supplies power to power circuitry 1687. As a further example, power source 1686 may comprise a source of power in the form of a battery or battery pack which is connected to, or integrated in, power circuitry 1687. The battery may provide backup power should the external power source fail. Other types of power sources, such as photovoltaic devices, may also be used.

Alternative embodiments of network node 1660 may include additional components beyond those shown in FIG. 16 that may be responsible for providing certain aspects of the network node's functionality, including any of the functionality described herein and/or any functionality necessary to support the subject matter described herein. For example, network node 1660 may include user interface equipment to allow input of information into network node 1660 and to allow output of information from network node 1660. This may allow a user to perform diagnostic, maintenance, repair, and other administrative functions for network node 1660.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (I) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1610 includes antenna 1611, interface 1614, processing circuitry 1620, device readable medium 1630, user interface equipment 1632, auxiliary equipment 1634, power source 1636 and power circuitry 1637. WD 1610 may include multiple sets of one or more of the illustrated components for different wireless technologies supported by WD 1610, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1610.

Antenna 1611 may include one or more antennas or antenna arrays, configured to send and/or receive wireless signals, and is connected to interface 1614. In certain alternative embodiments, antenna 1611 may be separate from WD 1610 and be connectable to WD 1610 through an interface or port. Antenna 1611, interface 1614, and/or processing circuitry 1620 may be configured to perform any receiving or transmitting operations described herein as being performed by a WD. Any information, data and/or signals may be received from a network node and/or another WD. In some embodiments, radio front end circuitry and/or antenna 1611 may be considered an interface.

As illustrated, interface 1614 comprises radio front end circuitry 1612 and antenna 1611. Radio front end circuitry 1612 comprise one or more filters 1618 and amplifiers 1616. Radio front end circuitry 1614 is connected to antenna 1611 and processing circuitry 1620, and is configured to condition signals communicated between antenna 1611 and processing circuitry 1620. Radio front end circuitry 1612 may be coupled to or a part of antenna 1611. In some embodiments, WD 1610 may not include separate radio front end circuitry 1612; rather, processing circuitry 1620 may comprise radio front end circuitry and may be connected to antenna 1611. Similarly, in some embodiments, some or all of RF transceiver circuitry 1622 may be considered a part of interface 1614. Radio front end circuitry 1612 may receive digital data that is to be sent out to other network nodes or WDs via a wireless connection. Radio front end circuitry 1612 may convert the digital data into a radio signal having the appropriate channel and bandwidth parameters using a combination of filters 1618 and/or amplifiers 1616. The radio signal may then be transmitted via antenna 1611. Similarly, when receiving data, antenna 1611 may collect radio signals which are then converted into digital data by radio front end circuitry 1612. The digital data may be passed to processing circuitry 1620. In other embodiments, the interface may comprise different components and/or different combinations of components.

Processing circuitry 1620 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1610 components, such as device readable medium 1630, WD 1610 functionality. Such functionality may include providing any of the various wireless features or benefits discussed herein. For example, processing circuitry 1620 may execute instructions stored in device readable medium 1630 or in memory within processing circuitry 1620 to provide the functionality disclosed herein.

As illustrated, processing circuitry 1620 includes one or more of RF transceiver circuitry 1622, baseband processing circuitry 1624, and application processing circuitry 1626. In other embodiments, the processing circuitry may comprise different components and/or different combinations of components. In certain embodiments processing circuitry 1620 of WD 1610 may comprise a SOC. In some embodiments, RF transceiver circuitry 1622, baseband processing circuitry 1624, and application processing circuitry 1626 may be on separate chips or sets of chips. In alternative embodiments, part or all of baseband processing circuitry 1624 and application processing circuitry 1626 may be combined into one chip or set of chips, and RF transceiver circuitry 1622 may be on a separate chip or set of chips. In still alternative embodiments, part or all of RF transceiver circuitry 1622 and baseband processing circuitry 1624 may be on the same chip or set of chips, and application processing circuitry 1626 may be on a separate chip or set of chips. In yet other alternative embodiments, part or all of RF transceiver circuitry 1622, baseband processing circuitry 1624, and application processing circuitry 1626 may be combined in the same chip or set of chips. In some embodiments, RF transceiver circuitry 1622 may be a part of interface 1614. RF transceiver circuitry 1622 may condition RF signals for processing circuitry 1620.

In certain embodiments, some or all of the functionality described herein as being performed by a WD may be provided by processing circuitry 1620 executing instructions stored on device readable medium 1630, which in certain embodiments may be a computer-readable storage medium. In alternative embodiments, some or all of the functionality may be provided by processing circuitry 1620 without executing instructions stored on a separate or discrete device readable storage medium, such as in a hard-wired manner. In any of those particular embodiments, whether executing instructions stored on a device readable storage medium or not, processing circuitry 1620 can be configured to perform the described functionality. The benefits provided by such functionality are not limited to processing circuitry 1620 alone or to other components of WD 1610, but are enjoyed by WD 1610 as a whole, and/or by end users and the wireless network generally.

Processing circuitry 1620 may be configured to perform any determining, calculating, or similar operations (e.g., certain obtaining operations) described herein as being performed by a WD. These operations, as performed by processing circuitry 1620, may include processing information obtained by processing circuitry 1620 by, for example, converting the obtained information into other information, comparing the obtained information or converted information to information stored by WD 1610, and/or performing one or more operations based on the obtained information or converted information, and as a result of said processing making a determination.

Device readable medium 1630 may be operable to store a computer program, software, an application including one or more of logic, rules, code, tables, etc. and/or other instructions capable of being executed by processing circuitry 1620. Device readable medium 1630 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1620. In some embodiments, processing circuitry 1620 and device readable medium 1630 may be considered to be integrated.

User interface equipment 1632 may provide components that allow for a human user to interact with WD 1610. Such interaction may be of many forms, such as visual, audial, tactile, etc. User interface equipment 1632 may be operable to produce output to the user and to allow the user to provide input to WD 1610. The type of interaction may vary depending on the type of user interface equipment 1632 installed in WD 1610. For example, if WD 1610 is a smart phone, the interaction may be via a touch screen; if WD 1610 is a smart meter, the interaction may be through a screen that provides usage (e.g., the number of gallons used) or a speaker that provides an audible alert (e.g., if smoke is detected). User interface equipment 1632 may include input interfaces, devices and circuits, and output interfaces, devices and circuits. User interface equipment 1632 is configured to allow input of information into WD 1610, and is connected to processing circuitry 1620 to allow processing circuitry 1620 to process the input information. User interface equipment 1632 may include, for example, a microphone, a proximity or other sensor, keys/buttons, a touch display, one or more cameras, a USB port, or other input circuitry. User interface equipment 1632 is also configured to allow output of information from WD 1610, and to allow processing circuitry 1620 to output information from WD 1610. User interface equipment 1632 may include, for example, a speaker, a display, vibrating circuitry, a USB port, a headphone interface, or other output circuitry. Using one or more input and output interfaces, devices, and circuits, of user interface equipment 1632, WD 1610 may communicate with end users and/or the wireless network, and allow them to benefit from the functionality described herein.

Auxiliary equipment 1634 is operable to provide more specific functionality which may not be generally performed by WDs. This may comprise specialized sensors for doing measurements for various purposes, interfaces for additional types of communication such as wired communications etc. The inclusion and type of components of auxiliary equipment 1634 may vary depending on the embodiment and/or scenario.

Power source 1636 may, in some embodiments, be in the form of a battery or battery pack. Other types of power sources, such as an external power source (e.g., an electricity outlet), photovoltaic devices or power cells, may also be used. WD 1610 may further comprise power circuitry 1637 for delivering power from power source 1636 to the various parts of WD 1610 which need power from power source 1636 to carry out any functionality described or indicated herein. Power circuitry 1637 may in certain embodiments comprise power management circuitry. Power circuitry 1637 may additionally or alternatively be operable to receive power from an external power source; in which case WD 1610 may be connectable to the external power source (such as an electricity outlet) via input circuitry or an interface such as an electrical power cable. Power circuitry 1637 may also in certain embodiments be operable to deliver power from an external power source to power source 1636. This may be, for example, for the charging of power source 1636. Power circuitry 1637 may perform any formatting, converting, or other modification to the power from power source 1636 to make the power suitable for the respective components of WD 1610 to which power is supplied.

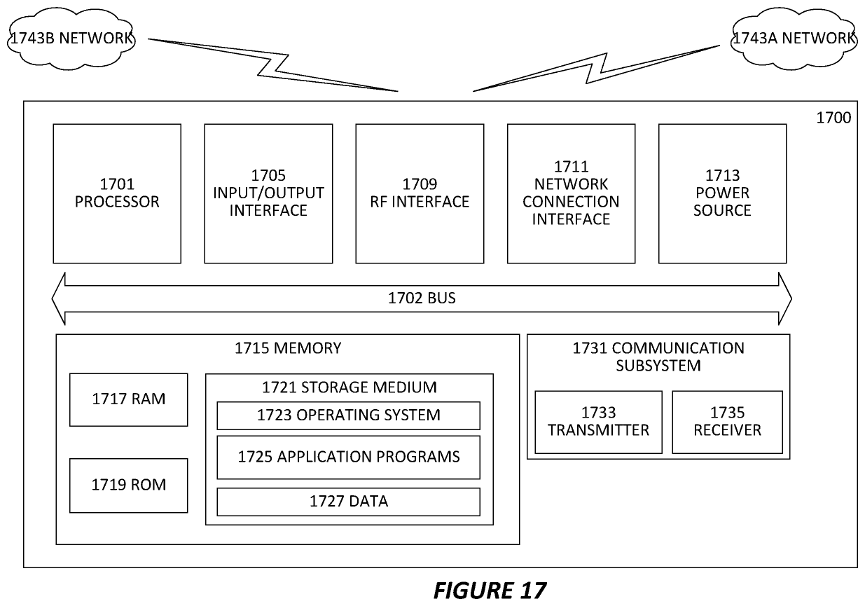

FIG. 17 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1700 may be any UE identified by the 3^{rd} Generation Partnership Project (3GPP), including a NB-IoT UE, a machine type communication (MTC) UE, and/or an enhanced MTC (eMTC) UE. UE 1700, as illustrated in FIG. 17, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 17 is a UE, the components discussed herein are equally applicable to a WD, and vice-versa.

In FIG. 17, UE 1700 includes processing circuitry 1701 that is operatively coupled to input/output interface 1705, radio frequency (RF) interface 1709, network connection interface 1711, memory 1715 including random access memory (RAM) 1717, read-only memory (ROM) 1719, and storage medium 1721 or the like, communication subsystem 1731, power source 1733, and/or any other component, or any combination thereof. Storage medium 1721 includes operating system 1723, application program 1725, and data 1727. In other embodiments, storage medium 1721 may include other similar types of information. Certain UEs may utilize all of the components shown in FIG. 17, or only a subset of the components. The level of integration between the components may vary from one UE to another UE. Further, certain UEs may contain multiple instances of a component, such as multiple processors, memories, transceivers, transmitters, receivers, etc.

In FIG. 17, processing circuitry 1701 may be configured to process computer instructions and data. Processing circuitry 1701 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1701 may include two central processing units (CPUs). Data may be information in a form suitable for use by a computer.

In the depicted embodiment, input/output interface 1705 may be configured to provide a communication interface to an input device, output device, or input and output device. UE 1700 may be configured to use an output device via input/output interface 1705. An output device may use the same type of interface port as an input device. For example, a USB port may be used to provide input to and output from UE 1700. The output device may be a speaker, a sound card, a video card, a display, a monitor, a printer, an actuator, an emitter, a smartcard, another output device, or any combination thereof. UE 1700 may be configured to use an input device via input/output interface 1705 to allow a user to capture information into UE 1700. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 17, RF interface 1709 may be configured to provide a communication interface to RF components such as a transmitter, a receiver, and an antenna. Network connection interface 1711 may be configured to provide a communication interface to network 1743a. Network 1743a may encompass wired and/or wireless networks such as a local-area network (LAN), a wide-area network (WAN), a computer network, a wireless network, a telecommunications network, another like network or any combination thereof. For example, network 1743a may comprise a Wi-Fi network. Network connection interface 1711 may be configured to include a receiver and a transmitter interface used to communicate with one or more other devices over a communication network according to one or more communication protocols, such as Ethernet, TCP/IP, SON ET, ATM, or the like. Network connection interface 1711 may implement receiver and transmitter functionality appropriate to the communication network links (e.g., optical, electrical, and the like). The transmitter and receiver functions may share circuit components, software or firmware, or alternatively may be implemented separately.

RAM 1717 may be configured to interface via bus 1702 to processing circuitry 1701 to provide storage or caching of data or computer instructions during the execution of software programs such as the operating system, application programs, and device drivers. ROM 1719 may be configured to provide computer instructions or data to processing circuitry 1701. For example, ROM 1719 may be configured to store invariant low-level system code or data for basic system functions such as basic input and output (I/O), startup, or reception of keystrokes from a keyboard that are stored in a non-volatile memory. Storage medium 1721 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1721 may be configured to include operating system 1723, application program 1725 such as a web browser application, a widget or gadget engine or another application, and data file 1727. Storage medium 1721 may store, for use by UE 1700, any of a variety of various operating systems or combinations of operating systems.

Storage medium 1721 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1721 may allow UE 1700 to access computer-executable instructions, application programs or the like, stored on transitory or non-transitory memory media, to off-load data, or to upload data. An article of manufacture, such as one utilizing a communication system may be tangibly embodied in storage medium 1721, which may comprise a device readable medium.

In FIG. 17, processing circuitry 1701 may be configured to communicate with network 1743b using communication subsystem 1731. Network 1743a and network 1743b may be the same network or networks or different network or networks. Communication subsystem 1731 may be configured to include one or more transceivers used to communicate with network 1743b. For example, communication subsystem 1731 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1733 and/or receiver 1735 to implement transmitter or receiver functionality, respectively, appropriate to the RAN links (e.g., frequency allocations and the like). Further, transmitter 1733 and receiver 1735 of each transceiver may share circuit components, software or firmware, or alternatively may be implemented separately.

In the illustrated embodiment, the communication functions of communication subsystem 1731 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1731 may include cellular communication, Wi-Fi communication, Bluetooth communication, and GPS communication. Network 1743b may encompass wired and/or wireless networks such as a local-area network (LAN), a wide-area network (WAN), a computer network, a wireless network, a telecommunications network, another like network or any combination thereof. For example, network 1743b may be a cellular network, a W-Fi network, and/or a near-field network. Power source 1713 may be configured to provide alternating current (AC) or direct current (DC) power to components of UE 1700.

The features, benefits and/or functions described herein may be implemented in one of the components of UE 1700 or partitioned across multiple components of UE 1700. Further, the features, benefits, and/or functions described herein may be implemented in any combination of hardware, software or firmware. In one example, communication subsystem 1731 may be configured to include any of the components described herein. Further, processing circuitry 1701 may be configured to communicate with any of such components over bus 1702. In another example, any of such components may be represented by program instructions stored in memory that when executed by processing circuitry 1701 perform the corresponding functions described herein. In another example, the functionality of any of such components may be partitioned between processing circuitry 1701 and communication subsystem 1731. In another example, the non-computationally intensive functions of any of such components may be implemented in software or firmware and the computationally intensive functions may be implemented in hardware.

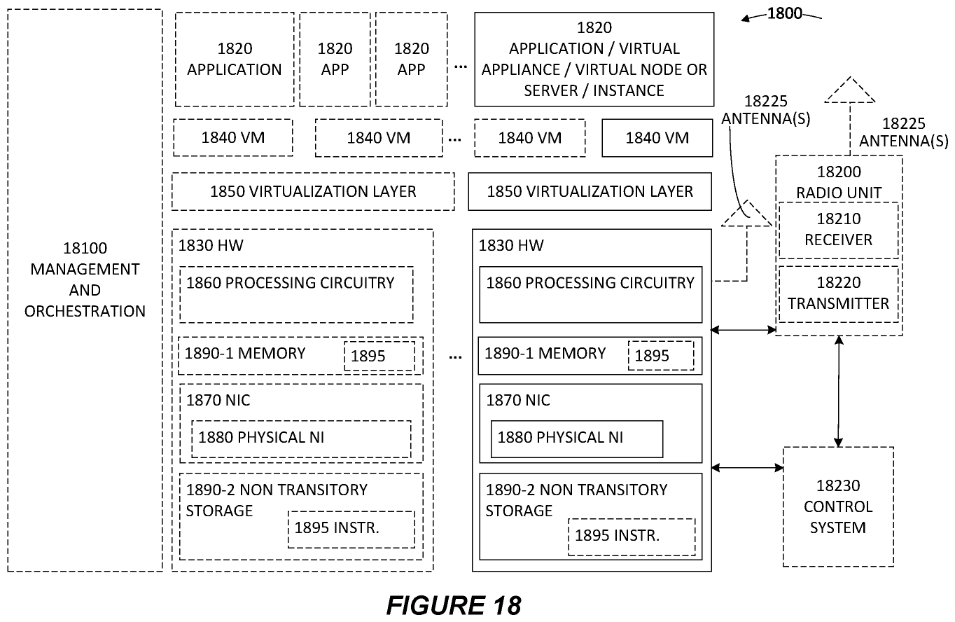

FIG. 18 is a schematic block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1800 hosted by one or more of hardware nodes 1830. Further, in embodiments in which the virtual node is not a radio access node or does not require radio connectivity (e.g., a core network node), then the network node may be entirely virtualized.

The functions may be implemented by one or more applications 1820 (which may alternatively be called software instances, virtual appliances, network functions, virtual nodes, virtual network functions, etc.) operative to implement some of the features, functions, and/or benefits of some of the embodiments disclosed herein. Applications 1820 are run in virtualization environment 1800 which provides hardware 1830 comprising processing circuitry 1860 and memory 1890. Memory 1890 contains instructions 1895 executable by processing circuitry 1860 whereby application 1820 is operative to provide one or more of the features, benefits, and/or functions disclosed herein.

Virtualization environment 1800, comprises general-purpose or special-purpose network hardware devices 1830 comprising a set of one or more processors or processing circuitry 1860, which may be commercial off-the-shelf (COTS) processors, dedicated Application Specific Integrated Circuits (ASICs), or any other type of processing circuitry including digital or analog hardware components or special purpose processors. Each hardware device may comprise memory 1890-1 which may be non-persistent memory for temporarily storing instructions 1895 or software executed by processing circuitry 1860. Each hardware device may comprise one or more network interface controllers (NICs) 1870, also known as network interface cards, which include physical network interface 1880. Each hardware device may also include non-transitory, persistent, machine-readable storage media 1890-2 having stored therein software 1895 and/or instructions executable by processing circuitry 1860. Software 1895 may include any type of software including software for instantiating one or more virtualization layers 1850 (also referred to as hypervisors), software to execute virtual machines 1840 as well as software allowing it to execute functions, features and/or benefits described in relation with some embodiments described herein.

Virtual machines 1840, comprise virtual processing, virtual memory, virtual networking or interface and virtual storage, and may be run by a corresponding virtualization layer 1850 or hypervisor. Different embodiments of the instance of virtual appliance 1820 may be implemented on one or more of virtual machines 1840, and the implementations may be made in different ways.

During operation, processing circuitry 1860 executes software 1895 to instantiate the hypervisor or virtualization layer 1850, which may sometimes be referred to as a virtual machine monitor (VMM). Virtualization layer 1850 may present a virtual operating platform that appears like networking hardware to virtual machine 1840.

As shown in FIG. 18, hardware 1830 may be a standalone network node with generic or specific components. Hardware 1830 may comprise antenna 18225 and may implement some functions via virtualization. Alternatively, hardware 1830 may be part of a larger cluster of hardware (e.g. such as in a data center or customer premise equipment (CPE)) where many hardware nodes work together and are managed via management and orchestration (MANO) 18100, which, among others, oversees lifecycle management of applications 1820.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1840 may be a software implementation of a physical machine that runs programs as if they were executing on a physical, non-virtualized machine. Each of virtual machines 1840, and that part of hardware 1830 that executes that virtual machine, be it hardware dedicated to that virtual machine and/or hardware shared by that virtual machine with others of the virtual machines 1840, forms a separate virtual network elements (VNE).

Still in the context of NFV, Virtual Network Function (VNF) is responsible for handling specific network functions that run in one or more virtual machines 1840 on top of hardware networking infrastructure 1830 and corresponds to application 1820 in FIG. 18.

In some embodiments, one or more radio units 18200 that each include one or more transmitters 18220 and one or more receivers 18210 may be coupled to one or more antennas 18225. Radio units 18200 may communicate directly with hardware nodes 1830 via one or more appropriate network interfaces and may be used in combination with the virtual components to provide a virtual node with radio capabilities, such as a radio access node or a base station.

In some embodiments, some signalling can be effected with the use of control system 18230 which may alternatively be used for communication between the hardware nodes 1830 and radio units 18200.

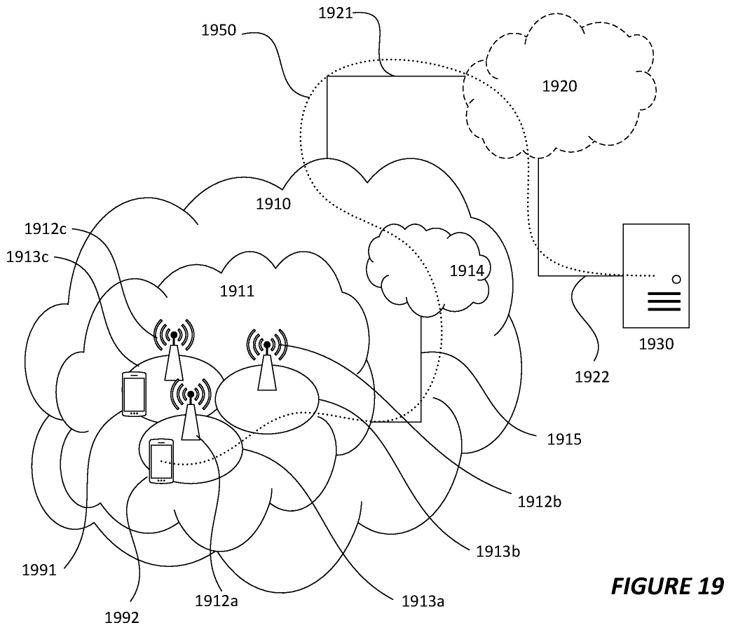

FIG. 19 illustrates a telecommunication network connected via an intermediate network to a host computer in accordance with some embodiments. In particular, with reference to FIG. 19, in accordance with an embodiment, a communication system includes telecommunication network 1910, such as a 3GPP-type cellular network, which comprises access network 1911, such as a radio access network, and core network 1914. Access network 1911 comprises a plurality of base stations 1912a, 1912b, 1912c, such as NBs, eNBs, gNBs or other types of wireless access points, each defining a corresponding coverage area 1913a, 1913b, 1913c. Each base station 1912a, 1912b, 1912c is connectable to core network 1914 over a wired or wireless connection 1915. A first UE 1991 located in coverage area 1913c is configured to wirelessly connect to, or be paged by, the corresponding base station 1912c. A second UE 1992 in coverage area 1913a is wirelessly connectable to the corresponding base station 1912a. While a plurality of UEs 1991, 1992 are illustrated in this example, the disclosed embodiments are equally applicable to a situation where a sole UE is in the coverage area or where a sole UE is connecting to the corresponding base station 1912.

Telecommunication network 1910 is itself connected to host computer 1930, which may be embodied in the hardware and/or software of a standalone server, a cloud-implemented server, a distributed server or as processing resources in a server farm. Host computer 1930 may be under the ownership or control of a service provider, or may be operated by the service provider or on behalf of the service provider. Connections 1921 and 1922 between telecommunication network 1910 and host computer 1930 may extend directly from core network 1914 to host computer 1930 or may go via an optional intermediate network 1920. Intermediate network 1920 may be one of, or a combination of more than one of, a public, private or hosted network; intermediate network 1920, if any, may be a backbone network or the Internet; in particular, intermediate network 1920 may comprise two or more sub-networks (not shown).

The communication system of FIG. 19 as a whole enables connectivity between the connected UEs 1991, 1992 and host computer 1930. The connectivity may be described as an over-the-top (OTT) connection 1950. Host computer 1930 and the connected UEs 1991, 1992 are configured to communicate data and/or signaling via OTT connection 1950, using access network 1911, core network 1914, any intermediate network 1920 and possible further infrastructure (not shown) as intermediaries. OTT connection 1950 may be transparent in the sense that the participating communication devices through which OTT connection 1950 passes are unaware of routing of uplink and downlink communications. For example, base station 1912 may not or need not be informed about the past routing of an incoming downlink communication with data originating from host computer 1930 to be forwarded (e.g., handed over) to a connected UE 1991. Similarly, base station 1912 need not be aware of the future routing of an outgoing uplink communication originating from the UE 1991 towards the host computer 1930.

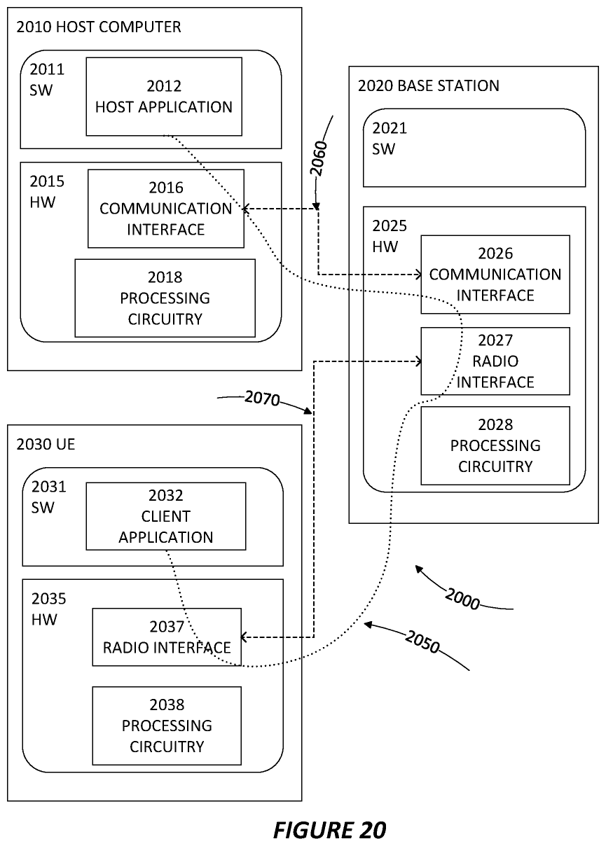

Example implementations, in accordance with an embodiment, of the UE, base station and host computer discussed in the preceding paragraphs will now be described with reference to FIG. 20. FIG. 20 illustrates host computer communicating via a base station with a user equipment over a partially wireless connection in accordance with some embodiments In communication system 2000, host computer 2010 comprises hardware 2015 including communication interface 2016 configured to set up and maintain a wired or wireless connection with an interface of a different communication device of communication system 2000. Host computer 2010 further comprises processing circuitry 2018, which may have storage and/or processing capabilities. In particular, processing circuitry 2018 may comprise one or more programmable processors, application-specific integrated circuits, field programmable gate arrays or combinations of these (not shown) adapted to execute instructions. Host computer 2010 further comprises software 2011, which is stored in or accessible by host computer 2010 and executable by processing circuitry 2018. Software 2011 includes host application 2012. Host application 2012 may be operable to provide a service to a remote user, such as UE 2030 connecting via OTT connection 2050 terminating at UE 2030 and host computer 2010. In providing the service to the remote user, host application 2012 may provide user data which is transmitted using OTT connection 2050.

Communication system 2000 further includes base station 2020 provided in a telecommunication system and comprising hardware 2025 enabling it to communicate with host computer 2010 and with UE 2030. Hardware 2025 may include communication interface 2026 for setting up and maintaining a wired or wireless connection with an interface of a different communication device of communication system 2000, as well as radio interface 2027 for setting up and maintaining at least wireless connection 2070 with UE 2030 located in a coverage area (not shown in FIG. 20) served by base station 2020. Communication interface 2026 may be configured to facilitate connection 2060 to host computer 2010. Connection 2060 may be direct or it may pass through a core network (not shown in FIG. 20) of the telecommunication system and/or through one or more intermediate networks outside the telecommunication system. In the embodiment shown, hardware 2025 of base station 2020 further includes processing circuitry 2028, which may comprise one or more programmable processors, application-specific integrated circuits, field programmable gate arrays or combinations of these (not shown) adapted to execute instructions. Base station 2020 further has software 2021 stored internally or accessible via an external connection.

Communication system 2000 further includes UE 2030 already referred to. Its hardware 2035 may include radio interface 2037 configured to set up and maintain wireless connection 2070 with a base station serving a coverage area in which UE 2030 is currently located. Hardware 2035 of UE 2030 further includes processing circuitry 2038, which may comprise one or more programmable processors, application-specific integrated circuits, field programmable gate arrays or combinations of these (not shown) adapted to execute instructions. UE 2030 further comprises software 2031, which is stored in or accessible by UE 2030 and executable by processing circuitry 2038. Software 2031 includes client application 2032. Client application 2032 may be operable to provide a service to a human or non-human user via UE 2030, with the support of host computer 2010. In host computer 2010, an executing host application 2012 may communicate with the executing client application 2032 via OTT connection 2050 terminating at UE 2030 and host computer 2010. In providing the service to the user, client application 2032 may receive request data from host application 2012 and provide user data in response to the request data. OTT connection 2050 may transfer both the request data and the user data. Client application 2032 may interact with the user to generate the user data that it provides.

It is noted that host computer 2010, base station 2020 and UE 2030 illustrated in FIG. 20 may be similar or identical to host computer 1930, one of base stations 1912a, 1912b, 1912c and one of UEs 1991, 1992 of FIG. 19, respectively. This is to say, the inner workings of these entities may be as shown in FIG. 20 and independently, the surrounding network topology may be that of FIG. 19.

In FIG. 20, OTT connection 2050 has been drawn abstractly to illustrate the communication between host computer 2010 and UE 2030 via base station 2020, without explicit reference to any intermediary devices and the precise routing of messages via these devices. Network infrastructure may determine the routing, which it may be configured to hide from UE 2030 or from the service provider operating host computer 2010, or both. While OTT connection 2050 is active, the network infrastructure may further take decisions by which it dynamically changes the routing (e.g., on the basis of load balancing consideration or reconfiguration of the network).

Wireless connection 2070 between UE 2030 and base station 2020 is in accordance with the teachings of the embodiments described throughout this disclosure. One or more of the various embodiments improve the performance of OTT services provided to UE 2030 using OTT connection 2050, in which wireless connection 2070 forms the last segment. More precisely, the teachings of these embodiments may reduce signaling overhead and/or improve network coverage, latency and/or power consumption, and thereby provide benefits such as increased service availability, reduced user waiting time, better responsiveness, and/or extended battery lifetime.

A measurement procedure may be provided for the purpose of monitoring data rate, latency and other factors on which the one or more embodiments improve. There may further be an optional network functionality for reconfiguring OTT connection 2050 between host computer 2010 and UE 2030, in response to variations in the measurement results. The measurement procedure and/or the network functionality for reconfiguring OTT connection 2050 may be implemented in software 2011 and hardware 2015 of host computer 2010 or in software 2031 and hardware 2035 of UE 2030, or both. In embodiments, sensors (not shown) may be deployed in or in association with communication devices through which OTT connection 2050 passes; the sensors may participate in the measurement procedure by supplying values of the monitored quantities exemplified above, or supplying values of other physical quantities from which software 2011, 2031 may compute or estimate the monitored quantities. The reconfiguring of OTT connection 2050 may include message format, retransmission settings, preferred routing etc.; the reconfiguring need not affect base station 2020, and it may be unknown or imperceptible to base station 2020. Such procedures and functionalities may be known and practiced in the art. In certain embodiments, measurements may involve proprietary UE signaling facilitating host computer 2010's measurements of throughput, propagation times, latency and the like. The measurements may be implemented in that software 2011 and 2031 causes messages to be transmitted, in particular empty or ‘dummy’ messages, using OTT connection 2050 while it monitors propagation times, errors etc.

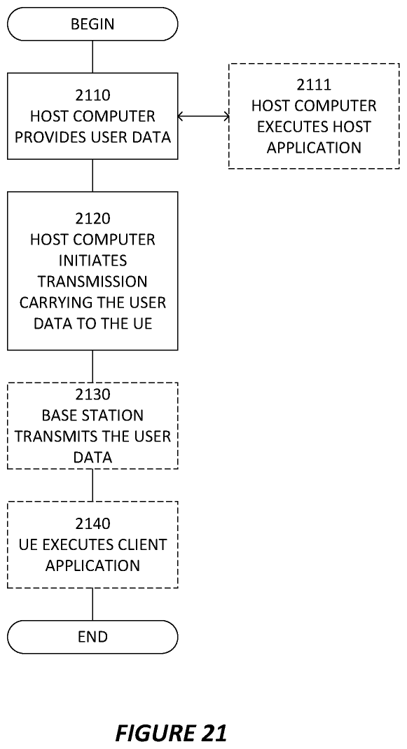

FIG. 21 is a flowchart illustrating a method implemented in a communication system, in accordance with one embodiment. The communication system includes a host computer, a base station and a UE which may be those described with reference to FIGS. 19 and 20. For simplicity of the present disclosure, only drawing references to FIG. 21 will be included in this section. In step 2110, the host computer provides user data. In substep 2111 (which may be optional) of step 2110, the host computer provides the user data by executing a host application. In step 2120, the host computer initiates a transmission carrying the user data to the UE. In step 2130 (which may be optional), the base station transmits to the UE the user data which was carried in the transmission that the host computer initiated, in accordance with the teachings of the embodiments described throughout this disclosure. In step 2140 (which may also be optional), the UE executes a client application associated with the host application executed by the host computer.

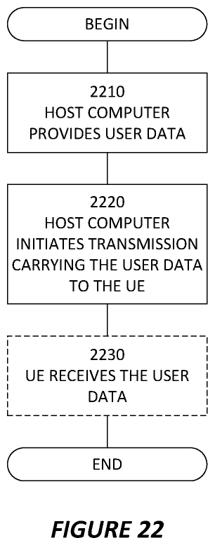

FIG. 22 is a flowchart illustrating a method implemented in a communication system, in accordance with one embodiment. The communication system includes a host computer, a base station and a UE which may be those described with reference to FIGS. 19 and 20. For simplicity of the present disclosure, only drawing references to FIG. 22 will be included in this section. In step 2210 of the method, the host computer provides user data. In an optional substep (not shown) the host computer provides the user data by executing a host application. In step 2220, the host computer initiates a transmission carrying the user data to the UE. The transmission may pass via the base station, in accordance with the teachings of the embodiments described throughout this disclosure. In step 2230 (which may be optional), the UE receives the user data carried in the transmission.

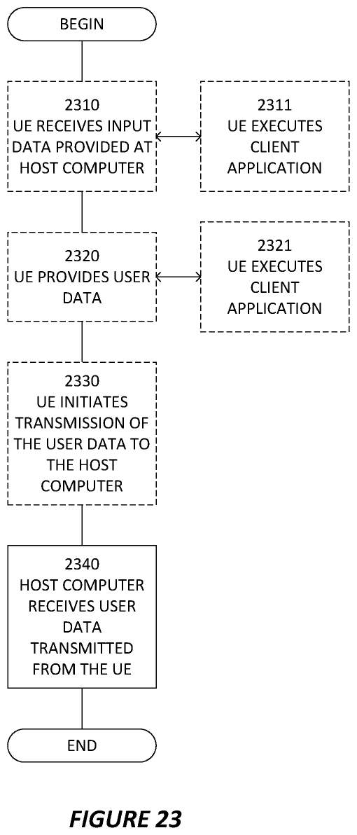

FIG. 23 is a flowchart illustrating a method implemented in a communication system, in accordance with one embodiment. The communication system includes a host computer, a base station and a UE which may be those described with reference to FIGS. 19 and 20. For simplicity of the present disclosure, only drawing references to FIG. 23 will be included in this section. In step 2310 (which may be optional), the UE receives input data provided by the host computer. Additionally or alternatively, in step 2320, the UE provides user data. In substep 2321 (which may be optional) of step 2320, the UE provides the user data by executing a client application. In substep 2311 (which may be optional) of step 2310, the UE executes a client application which provides the user data in reaction to the received input data provided by the host computer. In providing the user data, the executed client application may further consider user input received from the user. Regardless of the specific manner in which the user data was provided, the UE initiates, in substep 2330 (which may be optional), transmission of the user data to the host computer. In step 2340 of the method, the host computer receives the user data transmitted from the UE, in accordance with the teachings of the embodiments described throughout this disclosure.

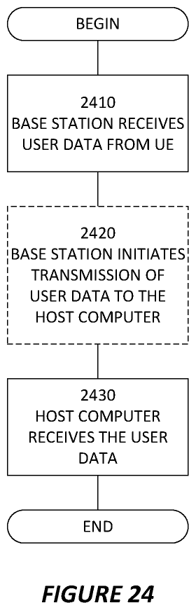

FIG. 24 is a flowchart illustrating a method implemented in a communication system, in accordance with one embodiment. The communication system includes a host computer, a base station and a UE which may be those described with reference to FIGS. 19 and 20. For simplicity of the present disclosure, only drawing references to FIG. 24 will be included in this section. In step 2410 (which may be optional), in accordance with the teachings of the embodiments described throughout this disclosure, the base station receives user data from the UE. In step 2420 (which may be optional), the base station initiates transmission of the received user data to the host computer. In step 2430 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In view of the above, then, embodiments herein generally include a communication system including a host computer. The host computer may comprise processing circuitry configured to provide user data. The host computer may also comprise a communication interface configured to forward the user data to a cellular network for transmission to a user equipment (UE). The cellular network may comprise a base station having a radio interface and processing circuitry, the base station's processing circuitry configured to perform any of the steps of any of the embodiments described above for a base station.

In some embodiments, the communication system further includes the base station.

In some embodiments, the communication system further includes the UE, wherein the UE is configured to communicate with the base station.

In some embodiments, the processing circuitry of the host computer is configured to execute a host application, thereby providing the user data. In this case, the UE comprises processing circuitry configured to execute a client application associated with the host application.

Embodiments herein also include a method implemented in a communication system including a host computer, a base station and a user equipment (UE). The method comprises, at the host computer, providing user data. The method may also comprise, at the host computer, initiating a transmission carrying the user data to the UE via a cellular network comprising the base station. The base station performs any of the steps of any of the embodiments described above for a base station.

In some embodiments, the method further comprising, at the base station, transmitting the user data.

In some embodiments, the user data is provided at the host computer by executing a host application. In this case, the method further comprises, at the UE, executing a client application associated with the host application.

Embodiments herein also include a user equipment (UE) configured to communicate with a base station. The UE comprises a radio interface and processing circuitry configured to perform any of the embodiments above described for a UE.

Embodiments herein further include a communication system including a host computer. The host computer comprises processing circuitry configured to provide user data, and a communication interface configured to forward user data to a cellular network for transmission to a user equipment (UE). The UE comprises a radio interface and processing circuitry. The UE's components are configured to perform any of the steps of any of the embodiments described above for a UE.

In some embodiments, the cellular network further includes a base station configured to communicate with the UE.

In some embodiments, the processing circuitry of the host computer is configured to execute a host application, thereby providing the user data. The UE's processing circuitry is configured to execute a client application associated with the host application.

Embodiments also include a method implemented in a communication system including a host computer, a base station and a user equipment (UE). The method comprises, at the host computer, providing user data and initiating a transmission carrying the user data to the UE via a cellular network comprising the base station. The UE performs any of the steps of any of the embodiments described above for a UE.

In some embodiments, the method further comprises, at the UE, receiving the user data from the base station.

Embodiments herein further include a communication system including a host computer. The host computer comprises a communication interface configured to receive user data originating from a transmission from a user equipment (UE) to a base station. The UE comprises a radio interface and processing circuitry. The UE's processing circuitry is configured to perform any of the steps of any of the embodiments described above for a UE.

In some embodiments the communication system further includes the UE.

In some embodiments, the communication system further including the base station. In this case, the base station comprises a radio interface configured to communicate with the UE and a communication interface configured to forward to the host computer the user data carried by a transmission from the UE to the base station.

In some embodiments, the processing circuitry of the host computer is configured to execute a host application. And the UE's processing circuitry is configured to execute a client application associated with the host application, thereby providing the user data.

In some embodiments, the processing circuitry of the host computer is configured to execute a host application, thereby providing request data. And the UE's processing circuitry is configured to execute a client application associated with the host application, thereby providing the user data in response to the request data.

Embodiments herein also include a method implemented in a communication system including a host computer, a base station and a user equipment (UE). The method comprises, at the host computer, receiving user data transmitted to the base station from the UE. The UE performs any of the steps of any of the embodiments described above for the UE.

In some embodiments, the method further comprises, at the UE, providing the user data to the base station.

In some embodiments, the method also comprises, at the UE, executing a client application, thereby providing the user data to be transmitted. The method may further comprise, at the host computer, executing a host application associated with the client application.

In some embodiments, the method further comprises, at the UE, executing a client application, and, at the UE, receiving input data to the client application. The input data is provided at the host computer by executing a host application associated with the client application. The user data to be transmitted is provided by the client application in response to the input data.

Embodiments also include a communication system including a host computer. The host computer comprises a communication interface configured to receive user data originating from a transmission from a user equipment (UE) to a base station. The base station comprises a radio interface and processing circuitry. The base station's processing circuitry is configured to perform any of the steps of any of the embodiments described above for a base station.

In some embodiments, the communication system further includes the base station.

In some embodiments, the communication system further includes the UE. The UE is configured to communicate with the base station.

In some embodiments, the processing circuitry of the host computer is configured to execute a host application. And the UE is configured to execute a client application associated with the host application, thereby providing the user data to be received by the host computer.

Embodiments moreover include a method implemented in a communication system including a host computer, a base station and a user equipment (UE). The method comprises, at the host computer, receiving, from the base station, user data originating from a transmission which the base station has received from the UE. The UE performs any of the steps of any of the embodiments described above for a UE.

In some embodiments, the method further comprises, at the base station, receiving the user data from the UE.

In some embodiments, the method further comprises, at the base station, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

1.-44. (canceled)

45. A method performed by a radio network node configured for use in a wireless communication network, the method comprising:
receiving a message of a procedure for random access by a wireless device to a cell served by the radio network node;
selecting, as a function of on which uplink bandwidth part of the cell the message was received and/or as a function of an information field of the message, a format of a random access response to be transmitted as a response to the message; and
transmitting the random access response with the selected format.

46. The method of claim 45, wherein different types of uplink bandwidth parts of the cell are associated with different random access response formats, and/or different Radio Resource Control states, and/or different random access triggering events.

47. The method of claim 45, wherein said selecting comprises selecting the format from among different candidate formats that have different sizes and/or at least some different fields.

48. The method of claim 45, wherein said selecting comprises selecting the format as a function of whether an uplink bandwidth part on which the message was received is an initial uplink bandwidth part or a non-initial uplink bandwidth part.

49. The method of claim 45, wherein said selecting comprises selecting the format to be a first format if the message was received on an initial uplink bandwidth part and selecting the format to be a second format if the message was received on a non-initial uplink bandwidth part, wherein the second format is smaller in size than the first format and/or has fewer fields than the first format.

50. The method of claim 45, wherein said selecting comprises selecting the format to be a first format if the information field indicates the random access response is to have the first format and selecting the format to be a second format if the information field indicates the random access response is to have the second format the second format, wherein the second format is smaller in size than the first format and/or has fewer fields than the first format.

51. The method of claim 45, wherein said selecting comprises selecting the format to be a first format if the information field indicates the wireless device is not in an RRC Connected state and selecting the format to be a second format if the information field indicates the wireless device is in an RRC Connected state, wherein the second format is smaller in size than the first format and/or has fewer fields than the first format.

52. The method of claim 49, wherein the first format includes either a Temporary Cell Radio Network Temporary Identifier (TC-RNTI) field, or a Cell Radio Network Temporary Identifier (C-RNTI) field, and wherein the second format lacks both a TC-RNTI field and a C-RNTI field.

53. The method of claim 49, wherein the first format includes a timing advance command (TAC) field and the second format lacks a TAC field.

54. The method of claim 45, wherein the selected format lacks both a Temporary Cell Radio Network Temporary Identifier (TC-RNTI) field and a Cell Radio Network Temporary Identifier (C-RNTI) field.

55. The method of claim 45, wherein the selected format lacks a timing advance command (TAC) field.

56. The method of claim 45, further comprising:
after transmitting the random access response, receiving a further message of the random access procedure; and
based on selecting the format of the random access response to be a format that lacks a Temporary Cell Radio Network Temporary Identifier (TC-RNTI) field, blindly decoding the further message using one or more Cell Radio Network Temporary Identifiers (C-RNTIs) allocated to one or more wireless devices that have a Radio Resource Control (RRC) connection established with the radio network node.

57. The method of claim 45, wherein the information field explicitly indicates either:
a format of the random access response to be transmitted; or
a Radio Resource Control state of the wireless device; or
a triggering event that triggered the procedure for random access.

58. A method performed by a wireless device configured for use in a wireless communication network, the method comprising:
transmitting a message of a procedure for random access to a cell, wherein the message:
is transmitted on an uplink bandwidth part selected based on a Radio Resource Control (RRC) state of the wireless device; and/or
includes an information field that explicitly indicates the RRC state of the wireless device, or a triggering event that triggered the procedure, or a format of a random access response to be transmitted as a response to the message.

59. The method of claim 58, further comprising:
selecting, based on the RRC state of the wireless device, the uplink bandwidth part on which to transmit the message; and
transmitting the message on the selected uplink bandwidth part.

60. The method of claim 59, wherein said selecting comprises selecting a non-initial uplink bandwidth part as the uplink bandwidth part on which to transmit the message if the wireless device is in an RRC Connected state and selecting an initial uplink bandwidth part as the uplink bandwidth part on which to transmit the message if the wireless device is not in an RRC Connected state.

61. The method of claim 58, wherein different types of uplink bandwidth parts of the cell are associated with different random access response formats, and/or different Radio Resource Control states, and/or different random access triggering events.

62. The method of claim 58, further comprising receiving a random access response as a response to the message, wherein the random access response has a format that is a function of on which uplink bandwidth part of the cell the message was transmitted.

63. A radio network node configured for use in a wireless communication network, the radio network node comprising:
communication circuitry; and
processing circuitry configured to cause the radio network node to:
receive a message of a procedure for random access by a wireless device to a cell served by the radio network node;
select, as a function of on which uplink bandwidth part of the cell the message was received and/or as a function of an information field of the message, a format of a random access response to be transmitted as a response to the message; and
transmit the random access response with the selected format.

64. A wireless device configured for use in a wireless communication network, the wireless device comprising:
communication circuitry; and
processing circuitry configured to cause the wireless device to transmit a message of a procedure for random access to a cell, wherein the message:
is transmitted on an uplink bandwidth part selected based on a Radio Resource Control (RRC) state of the wireless device; and/or
includes an information field that explicitly indicates the RRC state of the wireless device, a triggering event that triggered the procedure, or a format of a random access response to be transmitted as a response to the message.
